(19) United States
(12) Patent Application Publication
(10) Pub. No.: US 2015/0177957 A1
(43) Pub. Date: Jun. 25, 2015

(54) METHOD AND APPARATUS FOR PROCESSING OBJECT PROVIDED THROUGH DISPLAY

(71) Applicant: SAMSUNG ELECTRONICS CO., LTD., Gyeonggi-do (KR)

(72) Inventors: Hyerim Bae, Gyeonggi-do (KR); Kyungtae Kim, Gyeonggi-do (KR); Changhyup Jwa, Jeju-do (KR); Yangwook Kim, Gyeonggi-do (KR); Sunkee Lee, Gyeonggi-do (KR); Doosuk Kang, Gyeonggi-do (KR); Changho Lee, Gyeonggi-do (KR); Saemee Yim, Gyeonggi-do (KR)

(21) Appl. No.: 14/581,932

(22) Filed: Dec. 23, 2014

(30) Foreign Application Priority Data
Dec. 23, 2013 (KR) 10-2013-0160954

(51) Int. Cl. G06F 3/0484; G06F 3/0488

(52) U.S. Cl. CPC G06F 3/04842; G06F 3/0488

(57) ABSTRACT

A method of executing a function in response to a touch input by a user on a touch screen and an electronic device implementing the same is provided. The method of processing an object through an electronic device includes displaying a plurality of objects through a display functionally connected to the electronic device. The method of processing the object through an electronic device also includes obtaining an input corresponding to a first object among the plurality of objects. The method of processing the object through an electronic device further includes determining a second object related to the input among the plurality of objects. The method of processing the object through an electronic device includes displaying execution information of a function corresponding to the first object and object information related to the second object through the display.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0160954, filed on Dec. 23, 2013, which is hereby incorporated by reference for all purposes as if fully set forth herein.

### TECHNICAL FIELD

The present disclosure relates generally to an object processing method, and more particular to a method and an apparatus for processing an object provided through a display.

### BACKGROUND

An electronic device is an input means and can include, for example, a touch panel installed in a screen. Further, the electronic device detects a touch input by a user through a touch screen (for example, the screen equipped with the touch panel) and recognizes a location on the touch screen corresponding to the touch input. The electronic device processes an object exiting on the recognized location and executes, for example, a function corresponding to the object (for example, a function of the electronic device or an application function).

### SUMMARY

A function executed in an electronic device may not be a function which a user desires. For example, hyperlinked objects can be concentrated and displaying on a webpage. At this time, an unintended object is selected and a webpage linked to the unintended object is executed (for example, displayed through a touch screen). In a method of preventing such an execution error, the electronic device enlarges and displays objects of which at least a part is included within a preset radius with a touch position (for example, a coordinate of the touch screen corresponding to a touch input) as the center. The electronic device executes a function of the electronic device corresponding to the object selected by the user from the enlarged objects. However, such a solution causes inconvenience in that even though an object which the user desires is selected, the user should select the same object again.

To address the above-discussed deficiencies, it is a primary object to provide a method and an apparatus for processing an object in which the user executes a desired function (for example, a function of the electronic device or an application function).

In a first example, a method of processing an object through an electronic device is provided. The method includes displaying a plurality of objects through a display functionally connected to the electronic device. The method also includes obtaining an input corresponding to a first object among the plurality of objects. The method further includes determining a second object related to the input among the plurality of objects. The method includes displaying execution information of a function corresponding to the first object and object information related to the second object through the display.

In second example, a method of processing an object through an electronic device is provided. The method includes obtaining an input by a user. The method also includes displaying execution information of a function corresponding to the obtained input and input information related to one or more inputs except for the obtained input through a display functionally connected to the electronic device.

In a third example, an electronic device is provided. The electronic device includes a display module. The display module includes a touch screen with a touch panel. The display module is configured to display a plurality of objects. The electronic device also includes a processor. The processor is configured to obtain an input corresponding to a first object among the objects through the touch panel. The processor is also configured to determine a second object related to the input among the objects. The processor is further configured to control the display module to display execution information of a function corresponding to the first object and object information related to the second object.

In a fourth example, an electronic device is provided. The electronic device includes a display module and a processor. The display module includes a touch screen with a touch panel. The processor is configured to obtain an input of a user through the touch panel, control the display module to display execution information of a function corresponding to the obtained input, and input information related to one or more second inputs except for the obtained input.

Various embodiments of the present disclosure may provide a method in which a user can execute a desired function, and an electronic device implementing the same. Various embodiments of the present disclosure may provide a method in which the user can cancel an executed function and execute another function through object information displayed through a display, and an electronic device implementing the same. Various embodiments of the present disclosure may provide a method in which the user can cancel an executed function and execute another function through input information displayed through a display, and an electronic device implementing the same.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example block diagram of an electronic device according to this disclosure;

FIG. 2 is an example block diagram of hardware according to this disclosure;

FIG. 3 is an example block diagram of a programming module according to this disclosure;

FIGS. 4A, 4B, 4C, and 4D are example web browser screens describing a process of displaying a webpage according to this disclosure;

FIGS. 5A and 5B are conceptual diagrams for describing an example a process of determining an object selected by the user from objects displayed on the touch screen and a neighboring candidate object according to this disclosure;

FIGS. 6A, 6B, and 6C are example reproduction screens for describing a process of reproducing a video according to this disclosure;

FIGS. 7A, 7B, 7C, 7D, 7E, 7F, and 7G illustrate various example objects which can be selected according to a touch input;

FIGS. 8A, 8B, and 8C are example text input boxes for describing a process of reconfiguring a position of a cursor according to this disclosure;

FIGS. 9A, 9B, 9C, and 9D are example web browser screens for describing a process of displaying a webpage according to this disclosure;

FIG. 10 illustrates examples of various gestures which can be recognized by a processor according to this disclosure;

FIGS. 11A, 11B, 11C, 11D, 11E, 11F, and 11G are example views describing a method of arranging candidates according to this disclosure;

FIGS. 12, 13A, 13B, and 13C are example views describing a method of displaying candidate objects in various forms according to this disclosure;

FIG. 14 is a view describing an example of a method of operating a candidate list according to this disclosure;

FIGS. 15A, 15B, and 15C are example web browser screens for describing a process of displaying a webpage according to this disclosure;

FIGS. 16A, 16B, and 16C are example web browser screens for describing a process of displaying a webpage according to this disclosure;

FIGS. 17A and 17B are views describing an example method of placing a list of candidate objects on a screen according to this disclosure;

FIGS. 18A, 18B, and 18C are views describing an example method of configuring whether to operate a candidate list according to this disclosure; and

FIG. 19 is a flowchart illustrating an example method of executing a function of an electronic device according to this disclosure.

### DETAILED DESCRIPTION

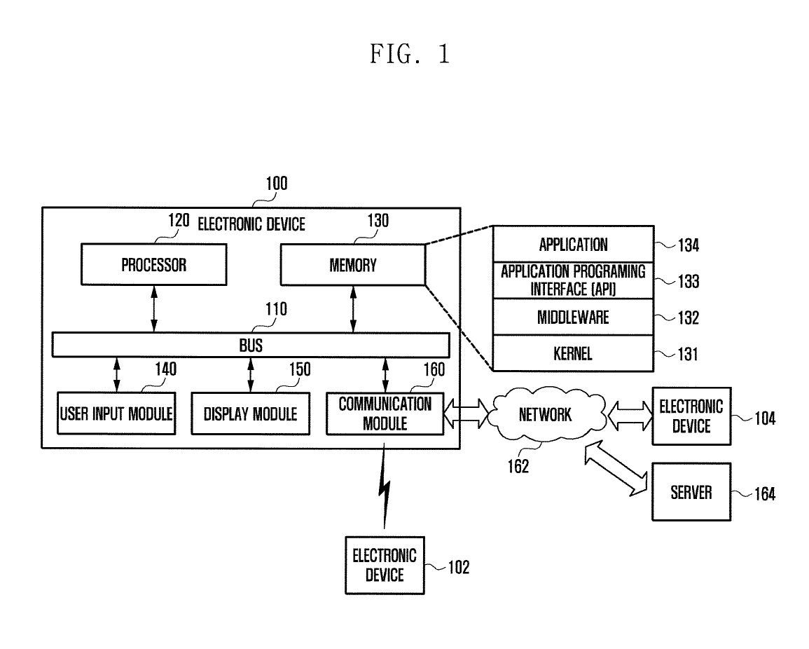

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

An electronic apparatus according to the present disclosure is an apparatus having a communication function. For example, the electronic device is at least one of a smart phone, a tablet Personal Computer (PC), a mobile phone, a video phone, an electronic-boot (e-book) reader, a desktop PC, a laptop PC, a netbook computer, a Personal Digital Assistant (PDA), a Portable Multimedia Player (PMP), an MP3 player, a mobile medical appliance, an electronic bracelet, an electronic necklace, an electronic accessory, a camera, a wearable device, an electronic clock, a wrist watch, home appliances, such as a refrigerator, an air conditioner, a cleaner, an oven, a microwave oven, a washing machine, an air cleaner, and the like, an artificial intelligence robot, a television, a Digital Video Disk (DVD) player, an audio player, various medical appliances, such as a Magnetic Resonance Angiography (MRA) device, a Magnetic Resonance Imaging (MRI) device, a Computerized Tomography (CT) device, an ultrasonography device and the like, a navigation device, a Global Positioning System (GPS) receiver, an Event Data Recorder (EDR), a Flight Data Recorder (FDR), a set-top box, a Television (TV) box, such as HomeSync™ of SAMSUNG Electronics, Co., Apple TV™ of APPLE, Co., and Google TV™ of Google, Co., an electronic dictionary, an infotainment device for a vehicle, an electronic equipment for a ship, such as a navigation device, a gyrocompass, etc., an avionic device, a security device, an electronic cloth, an electronic key, a camcorder, a game console, a Head-Mounted Display (HMD) unit, a flat panel display device, an electronic frame, an electronic album, a piece of furniture having a communication function and/or a part of a building/structure, an electronic board, an electronic signature receiving device, and a protector. It is obvious to those skilled in the art that the electronic device according to the present disclosure is not limited to the aforementioned devices.

FIG. 1 is a block diagram illustrating an example electronic apparatus according to this disclosure.

Referring to FIG. 1, the electronic apparatus 100 includes a bus 110, a processor 120, a memory 130, a user input module 140, a display module 150, and a communication module 160.

The bus 110 is a circuit for interconnecting elements described above and for allowing a communication, such as by transferring a control message between the elements described above.

The processor 120 receives commands from the above-mentioned other elements, such as the memory 130, the user input module 140, the display module 150, and the communication module 160, through, for example, the bus 110, deciphers the received commands, and performs operations and/or data processing according to the deciphered commands.

The memory 130 stores commands received from the processor 120 and/or other elements, such as the user input module 140, the display module 150, and the communication module 160, and/or commands and/or data generated by the processor 120 and/or other elements. The memory 130 includes programming modules, such as a kernel 131, middleware 132, an Application Programming Interface (API) 133, and an application 134. Each of the programming modules described above can be configured by software, firmware, hardware, and/or combinations of two or more thereof.

The kernel 131 controls and/or manages system resources, such as the bus 110, the processor 120 or the memory 130, used for execution of operations and/or functions implemented in other programming modules, such as the middleware 132, the API 133, and/or the application 134. Further, the kernel 131 provides an interface through which the middleware 132, the API 133, and/or the application 134 can access and then control and/or manage an individual element of the electronic apparatus 100.

The middleware 132 performs a relay function which allows the API 133 and/or the application 134 to communicate with and exchange data with the kernel 131. Further, in relation to operation requests received from at least one of an application 134, the middleware 132 performs load balancing in relation to the operation requests by, for example, giving a priority in using a system resource, such as the bus 110, the processor 120, and/or the memory 130, of the electronic apparatus 100 to at least one application from among the at least one of the application 134.

The API 133 is an interface through which the application 134 controls a function provided by the kernel 131 and/or the middleware 132, and can include, for example, at least one interface or function for file control, window control, image processing, and/or character control.

The user input module 140 receives, for example, a command and/or data from a user, and transfers the received command and/or data to the processor 120 and/or the memory 130 through the bus 110. The display module 150 displays an image, a video, and/or data to a user.

The communication module 160 establishes a communication between the electronic apparatus 100 and another electronic devices 102 and 104 and/or a server 164. The communication module 160 supports short range communication protocols, such as a Wireless Fidelity (WiFi) protocol, a BlueTooth (BT) protocol, and a Near Field Communication (NFC) protocol, communication networks, such as Internet, Local Area Network (LAN), Wire Area Network (WAN), a telecommunication network, a cellular network, and a satellite network, or a Plain Old Telephone Service (POTS), or any other similar and/or suitable communication networks, such as network 162, or the like. Each of the electronic devices 102 and 104 can be a same type and/or different types of electronic apparatus.

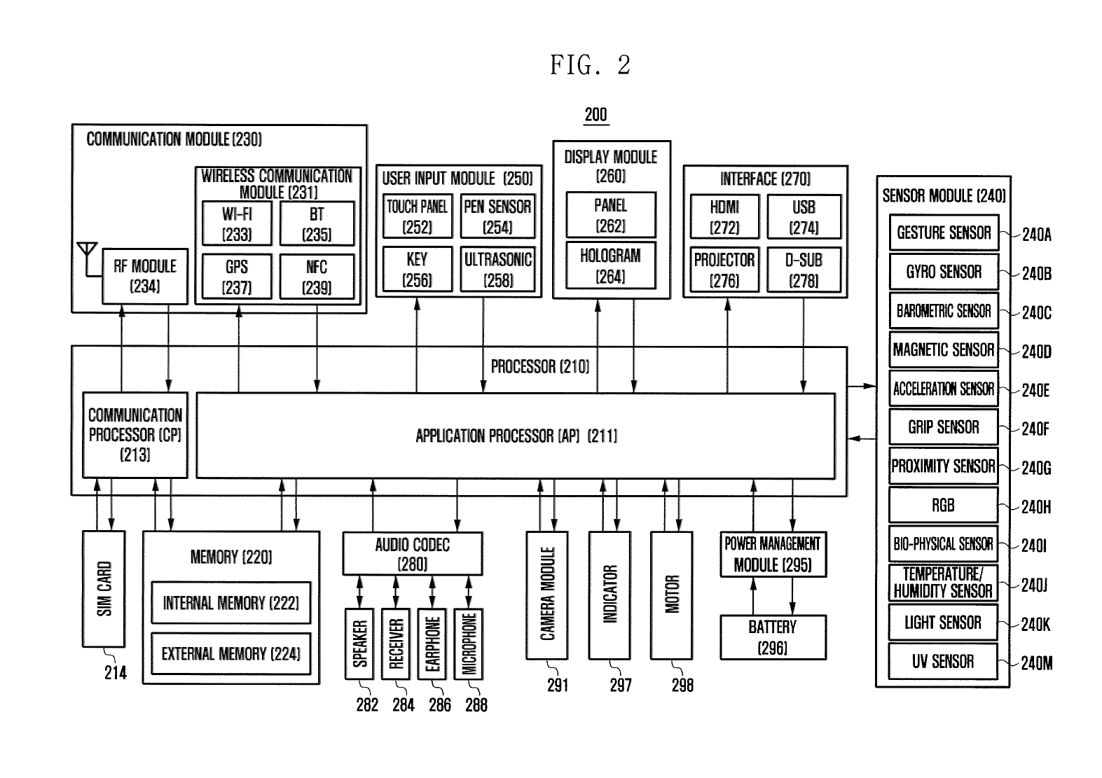

FIG. 2 is a block diagram illustrating an example hardware according to this disclosure.

A hardware 200 can be, for example, the electronic apparatus 100 illustrated in FIG. 1. Referring to FIG. 2, the hardware 200 includes at least one processor 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, and a motor 298.

The processor 210 includes at least one Application Processor (AP) 211 and/or at least one Communication Processor (CP) 213. The processor 210 can be, for example, similar to the processor 120 as illustrated in FIG. 1. Although FIG. 2 shows the AP 211 and the CP 213 included in the processor 210, the AP 211 and the CP 213 can be included in different Integrated Circuits (IC) packages, respectively. According to an embodiment, the AP 211 and the CP 213 can be included in a single IC package.

The AP 211 executes an OS or an application program to control a plurality of hardware and/or software elements connected to the AP 211 and performs processing and calculation of various data including the multimedia data. The AP 211 can be implemented by, for example, a System on Chip (SoC). According to an embodiment, the processor 210 can further include a Graphic Processing Unit (GPU).

The CP 213 performs functions of managing a data link and/or converting a communication protocol in communication between an electronic apparatus, such as the electronic apparatus 100, including the hardware 200 and/or another electronic apparatus connected through a network to the electronic apparatus. The CP 213 can be implemented by, for example, an SoC. According to an embodiment, the CP 213 performs at least a part of a multimedia control function. The CP 213 performs identification and authentication of a terminal in a communication network by using, for example, a user identification module, such as the SIM card 214. Further, the CP 213 provides services, such as a voice communication service, a video communication service, a short message service, and a packet data service, to a user.

Further, the CP 213 controls data transmission and/or reception of the communication module 230. Although the elements including the CP 213, the power management module 295, and the memory 220 are illustrated as being separate from the AP 211 in FIG. 2, the AP 211 can be implemented to include at least some, such as the CP 213, of the aforementioned elements according to an embodiment.

According to an embodiment, the AP 211 or the CP 213 loads a command and/or data received from at least one of a non-volatile memory and/or other elements connected thereto in a volatile memory and then processes the same. Further, the AP 211 or the CP 213 stores data received from and/or generated by at least one of the other elements in a non-volatile memory.

The SIM card 214 is a card implementing a SIM and is inserted in a slot formed at a particular position of an electronic apparatus. The SIM card 214 can include specific identification information, such as an Integrated Circuit Card IDentifier (ICCID), and/or subscriber information, such as an International Mobile Subscriber Identity (IMSI).

The memory 220 includes an internal memory 222 and/or an external memory 224. The memory 220 can be, for example, similar to the memory 130 as illustrated in FIG. 1. The internal memory 222 includes at least one of a volatile memory, such as such as a Dynamic Random Access Memory (DRAM), a Static RAM (SRAM), a Synchronous Dynamic RAM (SDRAM), or the like, and/or a non-volatile memory, such as such as a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like. According to an embodiment, the internal memory 222 can have a form of a Solid State Drive (SSD). The external memory 224 can further include a flash drive, for example, a Compact Flash (CF) drive, a Secure Digital (SD) drive, a Micro Secure Digital (Micro-SD) drive, a Mini Secure Digital (Mini-SD) drive, an extreme Digital (xD) drive, a memory stick, and/or the like.

The communication module 230 includes a wireless communication module 231 and/or a Radio Frequency (RF) module 234. The communication module 230 can be, for example, similar to the communication module 160 as illustrated in FIG. 1. The wireless communication module 231 can include, for example, a WiFi module 233, a BT module 235, a GPS receiving module 237, and/or a NFC module 239. For example, the wireless communication module 231 provides a wireless communication function by using a wireless frequency. Additionally or alternatively, the wireless communication module 231 can include a network interface, such as such as a LAN card, and/or a modem for connecting the hardware 200 with a network,(such as Internet, a LAN, a WAN, a telecommunication network, a cellular network, a satellite network, a Plain Old Telephone Service (POTS), and/or the like. The NFC module 239 includes a connection node for connection to an NFC antenna.

The RF module 234 performs data transmission/reception, for example, transmission and/or reception of an RF signal and/or a paged electronic signal. The RF module 234 includes, for example, a transceiver, a Power Amplifier Module (PAM), a frequency filter, a Low Noise Amplifier (LNA), and/or the like. Further, the RF module 234 can further include a component for transmitting and/or receiving an electromagnetic wave in a free space in a wireless and/or wired communication, for example, a conductor, a conductive wire, and/or the like.

The sensor module 240 includes, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green, Blue (RGB) sensor 240H, a bio-physical sensor 240I, a temperature/humidity sensor 240J, an illuminance sensor 240K, and an Ultra Violet (UV) sensor 240M. The sensor module 240 measures a physical property and/or detect an operation state of an electronic apparatus and converts the measured and/or detected information to an electric signal. Additionally/alternatively, the sensor module 240 includes, for example, an olfactory sensor, such as an E-nose sensor, an Electro MyoGraphy (EMG) sensor, an Electro EncephaloGram (EEG) sensor, an Electro CardioGram (ECG) sensor, a fingerprint sensor, or the like. The sensor module 240 may further include a control circuit for controlling at least one sensor included in the sensor module 240.

The user input module 250 includes a touch panel 252, a pen sensor 254, which may be a digital pen sensor 254, a key 256, and an ultrasonic input device 258. The user input module 250 can be, for example, the user input module 140, as illustrated in FIG. 1. The touch panel 252 detects a touch input in at least one scheme among, for example, a capacitive scheme, a resistive scheme, an infrared scheme, and an acoustic wave scheme. Further, the touch panel 252 can further includes a controller. In the case of the capacitive scheme, the touch panel recognizes an indirect touch as well as a direct touch. A direct touch scheme refers to a scheme in which a conductive object, such as a finger and/or a stylus pen makes a direct contact with a touch screen. According to an embodiment, an indirect touch scheme refers to a scheme in which a conductive material wrapped by a non-conductive material, such as a finger wearing a glove, approaches a touch screen and/or the non-conductive material, such as a glove which a finger is wearing, contacts the touch screen. According to an embodiment, the indirect touch scheme refers to a scheme in which a finger touches a non-conductive material, such as a cover for protecting a touch screen, in contact with an upper surface of the touch screen. According to an embodiment, the indirect touch scheme refers to a scheme, usually called hovering, in which an event is generated as a finger approaches a touch screen within a predetermined distance without coming into contact with the touch screen. The touch panel 252 can further include a tactile layer. In this event, the touch panel 252 provides a tactile response to a user. The touch panel 252 is provided at a screen, such as a touch screen, of the display module 260. The touch panel 252 is implemented as an add-on type in which the touch panel is located on the touch screen, and/or as an on-cell type and/or an in-cell type in which the touch panel is inserted in the display module 260.

The pen sensor 254 can be implemented, for example, in the same and/or similar method as that of receiving a user's touch input and/or by using a separate sheet for recognition. For example, a keypad and/or a touch key can be used as the key 256. The ultrasonic input device 258 is a device that identifies data by detecting a sound wave from a terminal to a microphone, such as a microphone 288, through a pen generating an ultrasonic wave signal, and can achieve wireless recognition. According to an embodiment, the hardware 200 receives a user input from an external device, such as such as a network, a computer, and/or a server connected with the communication module 230, by using the communication module 230.

The display module 260 can include a panel 262 and/or a hologram 264. The display module 260 can be, for example, similar to the display module 150 as illustrated in FIG. 1. For example, the panel 262 can be a Liquid Crystal Display (LCD) and/or an Active Matrix-Organic Light Emitting Diode (AM-OLED). The panel 262 can be implemented to be, for example, flexible, transparent, and/or wearable. The panel 262 can be configured by the touch panel 252 and one module. The hologram 264 can show a three dimensional image in the air by using an interference of light. According to an embodiment, the display module 260 can further include a control circuit for controlling the panel 262 and/or the hologram 264.

The interface 270 includes, for example, a High-Definition Multimedia Interface (HDMI) 272, a Universal Serial Bus (USB) 274, a projector 276, and a D-subminiature (D-sub) 278. Additionally or alternatively, the interface 270 can include, for example, a SD drive, a Multi-Media Card (MMC), and/or an Infrared Data Association (IrDA) interface.

The audio codec 280 bilaterally converts a voice and an electrical signal to each other. The audio codec 280 converts voice information input and/or output through, for example, a speaker 282, a receiver 284, an earphone 286, and/or the microphone 288.

The camera module 291 is a device capable of photographing a still image and a moving image, and can include at least one image sensor, such as such as a front lens and/or a rear lens, an Image Signal Processor (ISP), and/or a flash LED according to an embodiment.

The power management module 295 manages power of the hardware 200. The power management module 295 can include, for example, a Power Management IC (PMIC), a charger IC, and/or a battery gauge.

The PMIC can be mounted in, for example, an IC and/or an SoC semiconductor. Charging methods are classified into a wired charging method and a wireless charging method. The charger IC charges a battery and prevents introduction of over-voltage and/or over-current from a charger. According to an embodiment, the charger IC includes a charger IC for at least one of the wired charging method and the wireless charging method. A magnetic resonance scheme, a magnetic induction scheme, and/or an electromagnetic scheme can be exemplified as the wireless charging method, and an additional circuit for wireless charging, such as a coil loop circuit, a resonance circuit, a rectifier circuit, and the like may be added.

The battery gauge measures, for example, a residual quantity of the battery 296, and a voltage, a current, and/or a temperature during the charging. The battery 296 supplies power by generating electricity, and can be, for example, a rechargeable battery.

The indicator 297 displays a specific state, for example, a booting state, a message state, and/or a charging state of the hardware 200 and/or a part of the hardware, such as the AP 211. The motor 298 converts an electrical signal into a mechanical vibration.

The hardware 200 includes a processing unit, such as a GPU for supporting a mobile TV. The processing unit for supporting a mobile TV processes media data according to a standard of Digital Multimedia Broadcasting (DMB), Digital Video Broadcasting (DVB), media flow, or the like. Each of elements of the hardware can be configured by one or more components, which may have different names according to the type of the electronic apparatus. The hardware can include at least one of the aforementioned elements and/or can further include other additional elements, and/or some of the aforementioned elements can be omitted. Further, some of the elements of the hardware according to the present disclosure can be combined into one entity, which can perform the same functions as those of the elements before the combination.

The term “module” used in the present disclosure refers to, for example, a unit including at least one combination of hardware, software, and firmware. The “module” can be interchangeably used with a term, such as unit, logic, logical block, component, and/or circuit. The “module” can be a minimum unit of an integrally configured article and/or a part thereof The “module” can be a minimum unit performing at least one function and/or a part thereof The “module” can be mechanically and/or electronically implemented. For example, the “module” can include at least one of an Application-Specific ICt (ASIC) chip, a Field-Programmable Gate Arrays (FPGA), and a programmable-logic device for performing operations which has been known and/or are to be developed hereinafter.

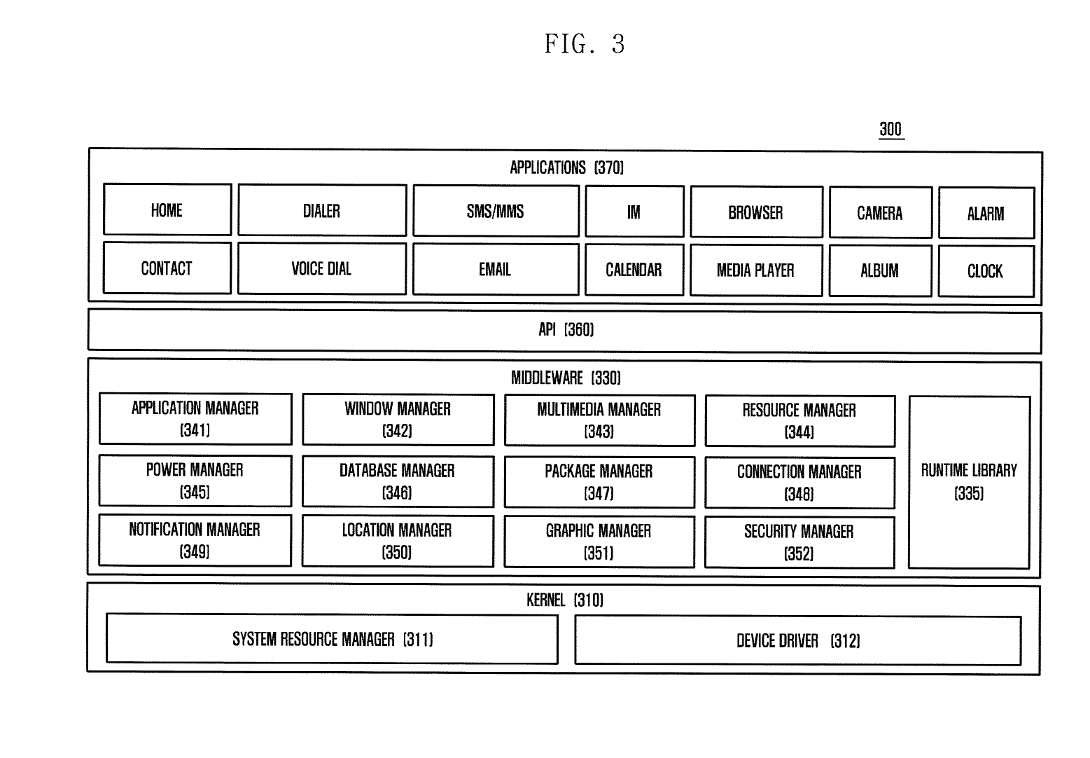

FIG. 3 is a block diagram illustrating an example programming module 300 according to this disclosure.

Referring to FIG. 3, the programming module 300 can be included, such as stored, in the electronic apparatus 100, such as the memory 130, as illustrated in FIG. 1. At least a part of the programming module 300 can be configured by software, firmware, hardware, and/or combinations of two or more thereof The programming module 300 includes an OS that is implemented in hardware, such as the hardware 200 to control resources related to an electronic device, such as the electronic device 100, and/or various applications, such as applications 370, driven on the OS. For example, the OS can be Android, iOS, Windows, Symbian, Tizen, Bada, or the like. Referring to FIG. 3, the programming module 300 includes a kernel 310, middleware 330, an API 360, and the applications 370.

The kernel 310, which can be like the kernel 131, includes a system resource manager 311 and/or a device driver 312. The system resource manager 311 can include, for example, a process manager, a memory manager, and a file system manager. The system resource manager 311 can control, allocate, and/or collect system resources. The device driver 312 can include, for example, a display driver, a camera driver, a Bluetooth driver, a shared memory driver, a USB driver, a keypad driver, a WiFi driver, and an audio driver. Further, according to an embodiment, the device driver 312 can include an Inter-Process Communication (IPC) driver (not illustrated).

The middleware 330 includes a plurality of modules implemented in advance for providing functions commonly used by the applications 370. Further, the middleware 330 provides the functions through the API 360 such that the applications 370 can efficiently use restricted system resources within the electronic apparatus. For example, as shown in FIG. 3, the middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include a library module that a compiler uses in order to add a new function through a programming language while one of the applications 370 is being executed. According to an embodiment, the runtime library 335 performs an input/output, memory management, and/or a function for an arithmetic function.

The application manager 341 manages a life cycle of at least one of the applications 370. The window manager 342 manages Graphical User Interface (GUI) resources used by a screen. The multimedia manager 343 detects formats used for reproduction of various media files, and performs encoding and/or decoding of a media file by using a codec suitable for the corresponding format. The resource manager 344 manages resources such as a source code, a memory, and a storage space of at least one of the applications 370.

The power manager 345 manages a battery and/or power, while operating together with a Basic Input/Output System (BIOS), and provides power information used for operation. The database manager 346 manages generation, search, and/or change of a database to be used by at least one of the applications 370. The package manager 347 manages installation and/or an updates of an application distributed in a form of a package file.

For example, the connectivity manager 348 manages wireless connectivity such as Wi-Fi or Bluetooth. The notification manager 349 displays and/or notifies of an event, such as an arrival message, a promise, a proximity notification, and the like, in such a way that does not disturb a user. The location manager 350 manages location information of an electronic apparatus. The graphic manager 351 manages a graphic effect which will be provided to a user, and/or a user interface related to the graphic effect. The security manager 352 provides all security functions used for system security and/or user authentication. According to an embodiment, when an electronic apparatus, such as the electronic apparatus 100, has a telephone call function, the middleware 330 further includes a telephony manager for managing a voice and/or video communication function of the electronic apparatus.

The middleware 330 generates and uses a new middleware module through various functional combinations of the aforementioned internal element modules. The middleware 330 provides modules specialized according to types of OSs in order to provide differentiated functions. Further, the middleware 330 dynamically removes some of the existing elements and/or add new elements. Accordingly, the middleware 330 excludes some of the elements described herein, further includes other elements, and/or substitute the elements with elements having a different name and performing a similar function.

The API 360, which may be similar to the API 133, is a set of API programming functions, and can be provided with a different configuration according to the OS. For example, in a case of Android or iOS, one API set is provided for each platform, and in a case of Tizen, two or more API sets are provided.

The applications 370 can include, for example, a preloaded application and/or a third party application.

At least a part of the programming module 300 can be implemented by commands stored in computer-readable storage media. When the commands are executed by at least one processor, such as the processor 210, at least one processor performs functions corresponding to the commands. The computer-readable storage media can be, for example, the memory 204. At least a part of the programming module 300 can be implemented, such as executed, by, for example, the processor 210. At least a part of the programming module 300 can include, for example, a module, a program, a routine, a set of instructions and/or a process for performing at least one function.

The titles of the aforementioned elements of the programming module, such as the programming module 300, can vary depending on the type of the OS. The programming module according to the present disclosure can include at least one of the aforementioned elements and/or can further include other additional elements, and/or some of the aforementioned elements can be omitted. The operations performed by a programming module and/or other elements according to the present disclosure can be processed through a sequential, parallel, repetitive, and/or heuristic method, and some of the operations can be omitted and/or other operations may be added.

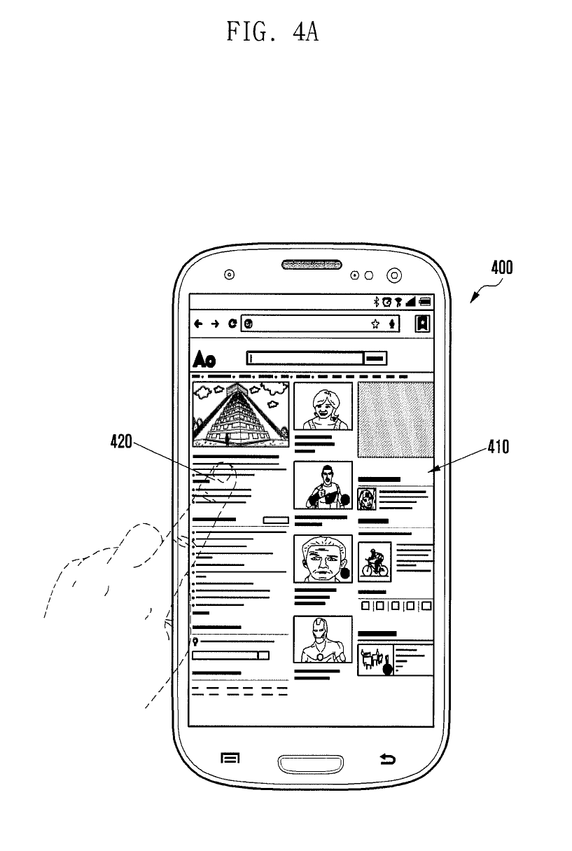

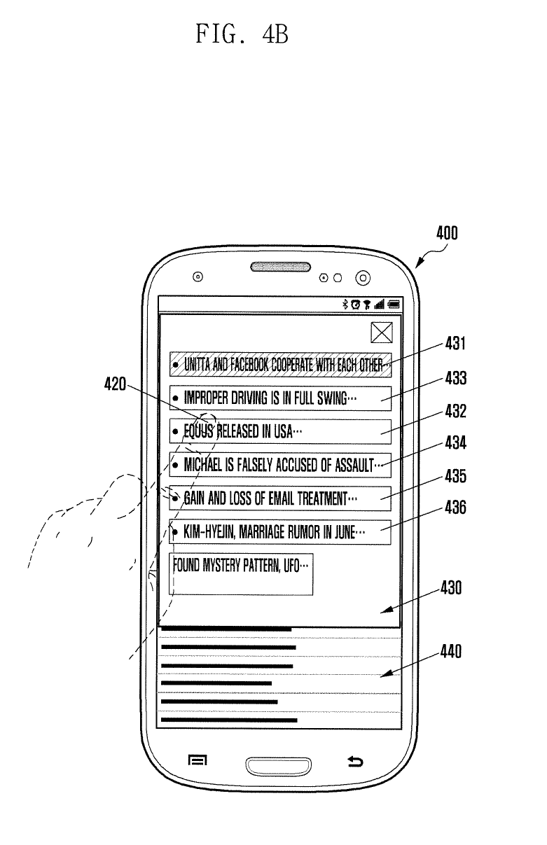

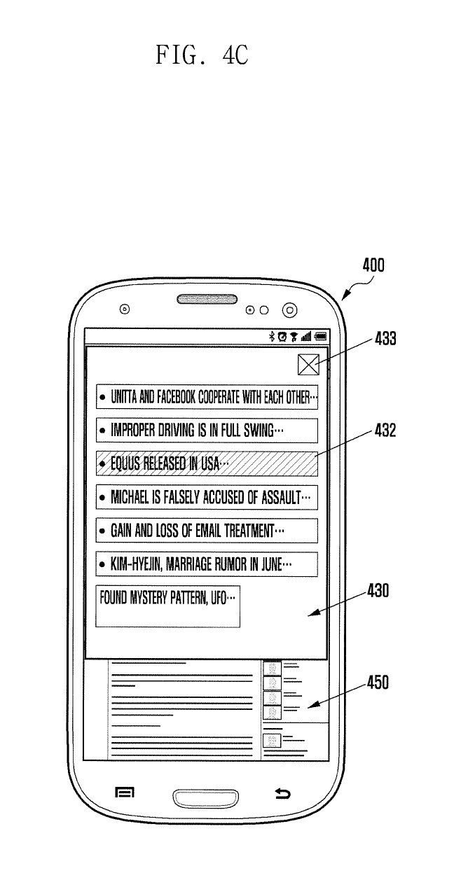

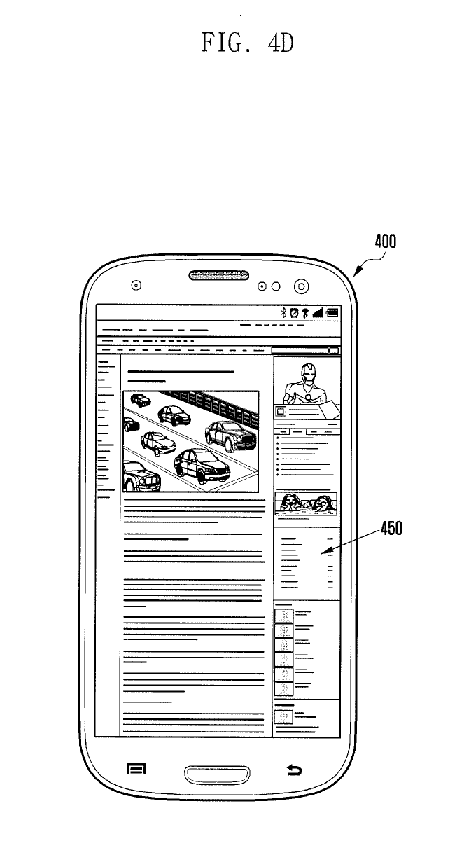

FIGS. 4A, 4B, 4C, and 4D are web browser screens for describing a process of displaying a webpage according to this disclosure.

Referring to FIG. 4A, a process (for example, the process 211) of an electronic device 400 (for example, the electronic device 200) controls a display (for example, the display module 260) to display a webpage 410. The screen is an application execution screen (for example, a web browser screen) and can be the entire screen of the corresponding electronic device or only part of it. The user can take a gesture (for example, a touch and then releases the touch within a specified time such as a tap) by using a finger 420 on the webpage 410 displayed on the screen of the electronic device 400. A touch panel (for example, the touch panel 252) of the electronic device 400 recognizes a tap and transmits information on the recognized tap to a processor.

The processor (for example, the processor 211) analyzes information on the tap to determine a touch position (for example, a touch coordinate). The processor recognizes an object corresponding to the touch position among objects of the webpage 410. For example, the processor distinguishes the objects of the webpage 410 based on, for example, a distinguisher (for example, a delimiter or a frame), a type (for example, an icon, an image, or text), or hyperlink. The delimiter can be, for example, an arrow, a figure, or a call symbol, and the frame can be, for example, a line between texts or a box.

Further, the processor can determine an object located among other objects in an area corresponding to a touch coordinate (for example, an area closest to the touch coordinate) as an object corresponding to a touch position. The processor executes a function corresponding to the determined object (for example, a function of the electronic device or an application function). For example, the determined object can be linked to a content (for example, a downloaded previous webpage or a new webpage which has not been downloaded yet). According to an embodiment, the processor can determine whether the recognized object is the previous webpage or the new webpage with reference to information related to the corresponding webpage, for example, address information or a reference field.

According to an embodiment, when the recognized object is the previous webpage, the processor accesses a memory (for example, the memory 204) to read the previous webpage. When the recognized object is the new webpage, the processor controls a communication module (for example, the communication module 230) to download the new webpage. According to an embodiment, the processor controls the display module 260 to display information designated for loading guidance (for example, a white image) during a time for which the webpage is loaded (for example, a reading time or a downloading time). According to an embodiment, the loading guidance information may not be displayed. For example, a target to be displayed can be changed from the webpage 410 to another webpage without displaying the loading guidance information.

According to any embodiment, the processor controls the display to display candidate lists for a designated time (for example, the loading time). According to an embodiment, the candidate lists can include one or more objects close to the recognized object. For example, the processor determines an area configured based on the touch coordinate as an area for determining the candidate lists (hereinafter, referred to as a “touch area” for convenience of the description). Further, the processor can determine an object existing within the touch area (for example, a case where at least a part of the object exists within the touch area or the object is completely included within the touch area) as a candidate to be included in the candidate lists.

Referring to FIG. 4B, the processor (for example, the processor 211) controls the display (for example, the display module 260) to display a candidate list 430 on the screen. According to an embodiment, the processor displays the candidate list 430 on at least a part of another webpage 440 through the display. The webpage 440 can be, for example, execution information of a function corresponding to an object selected by a user input. The execution information can be information provided to the user as a user interface through the display while the function corresponding to the object (for example, the webpage 440) is executed through the processor. According to any embodiment, the display can display the candidate list 430 together with the loading guidance information (for example, on the white image). According to an embodiment, the candidate list 430 can include candidate object(s) (for example, objects 432, 433, 434, 435, and 436) and an object 431 (for example, an object corresponding to the webpage 440 being currently executed) recognized by an input.

According to an embodiment, the candidate list 430 can be displayed together with the execution information corresponding to the recognized object 431 (for example, the webpage 440 displayed through the display). For example, the candidate list 430 can be displayed together with the execution information from a time point when the execution information is displayed on the display. Alternatively, the candidate list 430 can be displayed regardless of the displaying of the execution information corresponding to the recognized object 431. For example, the candidate list 430 can be displayed in advance before the execution information is displayed. Alternatively, the execution information can be first displayed and the candidate list 430 may be displayed based on a new input (for example, a designated touch input or hovering input).

According to an embodiment, the display can display the recognized object 431 with emphasis so that the recognized object 431 is distinguished from other objects (for example, a deep ground color as illustrated and corresponding text in bold type). Further, the display can display the objects of the candidate list 430 after enlarging the objects to make it larger than before. Further, the display can display the objects of the candidate list 430 such that an interval between the objects is further separated from each other than before. The user 420 can perform a touch input on at least one (for example, the candidate object 432) of the candidate objects of the candidate list 430. Then, the processor can recognize the candidate object 432 corresponding to the touch input among the candidate objects 432, 433, 434, 435, and 436.

Referring to FIG. 4C, the processor controls the display to display the recognized candidate object 432, for example, with emphasis so that the recognized candidate object 432 is distinguished from other objects. According to an embodiment, the processor executes a function corresponding to the newly recognized candidate object 432 (for example, a function of the electronic device or an application function). For example, the processor controls the display module 260 to display a webpage 450 linked to the selected candidate object 432 on the screen (for example, behind the candidate list 430). According to an embodiment, in order to execute the function corresponding to the newly recognized candidate object 432, the processor continuously executes a function of a previously selected object (for example, executes the function of the previously selected object together with the function corresponding to the newly selected object). Alternatively, the processor can stop executing the function of the previously selected object and execute the function of the newly selected object.

Referring to FIGS. 4C and 4D, the processor (for example, the processor 211) terminates the displaying of the candidate list 430. For example, when a termination button 433 is selected (for example, by the user) in the candidate list 430, the processor terminates the displaying of the candidate list 430 and controls to display only the webpage 450. The processor displays the candidate list 430 together with the webpage 450 while the webpage 450 is loaded. When the loading of the webpage 450 is completed, the processor terminates the displaying of the candidate list 430. Alternatively, the processor can immediately terminate the displaying of the candidate list 430 in response to a user input related to the termination button 433.

According to any embodiment, when the user input is not recognized for a designated time (for example, a loading time) in a state where the candidate list 430 is displayed, the processor can control to terminate the displaying of the candidate list 430 and display only the webpage 450. FIG. 4D illustrates an example of displaying the webpage 450 after completely terminating the displaying of the candidate list 430.

According to an embodiment, the termination button 433 can be inserted into the candidate list 430 based on the displaying of the candidate list 430 and be provided to the user together with the candidate list 430. According to another embodiment, the termination button 433 may not be displayed in the candidate list 430 and then can be displayed in the candidate list 430 based on a new user input when the new user input (for example, an input touching the candidate list 430 or a hovering input related to the candidate list 430) is obtained.

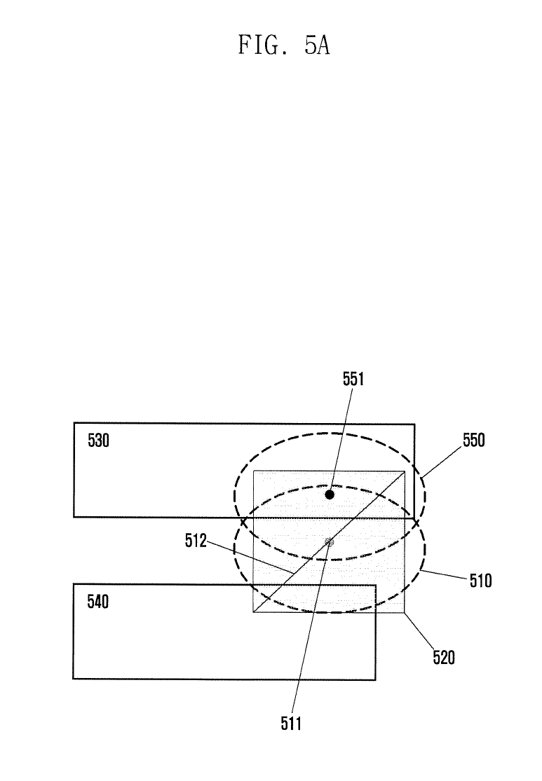

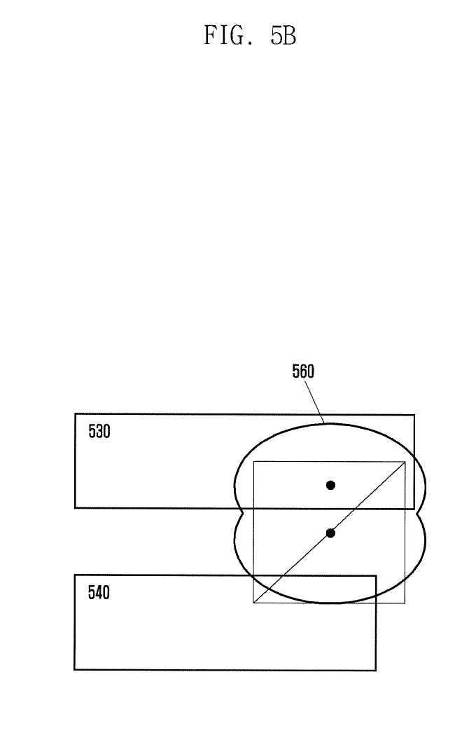

FIGS. 5A and 5B are conceptual diagrams for describing an example of a process of determining an object selected by the user from objects displayed on the touch screen and a neighboring candidate object according to this disclosure.

Referring to FIG. 5A, the processor (for example, the processor 211) analyzes a touch input to determine a touch area 510. The processor determines the center point of the touch area 510 as a touch position 511. The processor changes the touch area by using the touch position 511. For example, the processor determines a square area 520, which has a line 512 as a diagonal line thereof, as a changed touch area, the line 512 having the touch position 511 as the center. The changed touch area can have a different form, not the square. The processor 211 determines an object closest to the touch position 511, for example, an object 530, from among the other objects, to be the object selected by the user. Further, the processor 211 determines an object of which at least a part is included within the touch area 510 or the touch area 520, for example, an object 540, to be the candidate object. There may be no object of which at least a part is included with the touch area 510 or the touch area 520. Then, for example, the processor 211 can omit the display of the candidate list. According to any embodiment, regardless of whether at least a part of the object is included within the touch area 510 or the touch area 520 or not, the candidate list can be displayed. For example, the processor 211 determines an object (for example, the object 540) close to the object (for example, the object 530) selected by the user as the candidate object.

Referring back to FIG. 5A, the processor 211 changes a touch position 511 to a touch position 551 by using, for example, a known correction technology, for example, an interpolation algorithm or a noise removal algorithm. The processor 211 reconfigures the touch area 510 as the touch area 550 by using the touch position 551. The processor 211 determines the object 530 including the touch position 551 as the object selected by the user, from among the objects. Further, the processor 211 determines the object 540 of which at least a part is included within the reconfigured touch area 550 as the candidate object.

Referring to FIGS. 5A and 5B, the processor 211 reconfigures an area 560 including the touch area 510 and the touch area 550 as the touch area. The processor 211 determines an object (for example, the object 530) which has the largest part of itself located in the reconfigured touch area 560 among objects (for example, the objects 530 and 540) of which at least a part is included within the reconfigured touch area 560 to be the object selected by the user. Further, the processor 211 determines the remaining objects (for example, the object 540) as the candidate object.

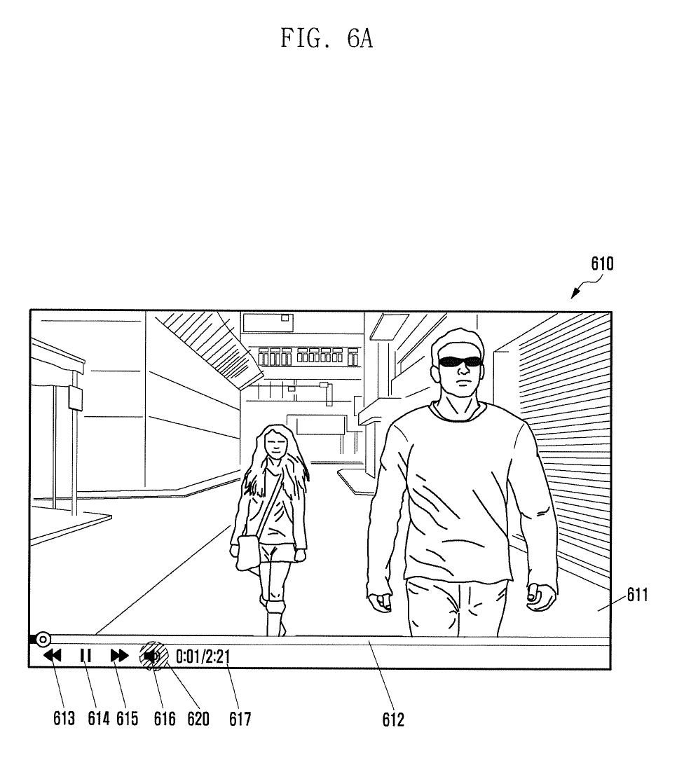

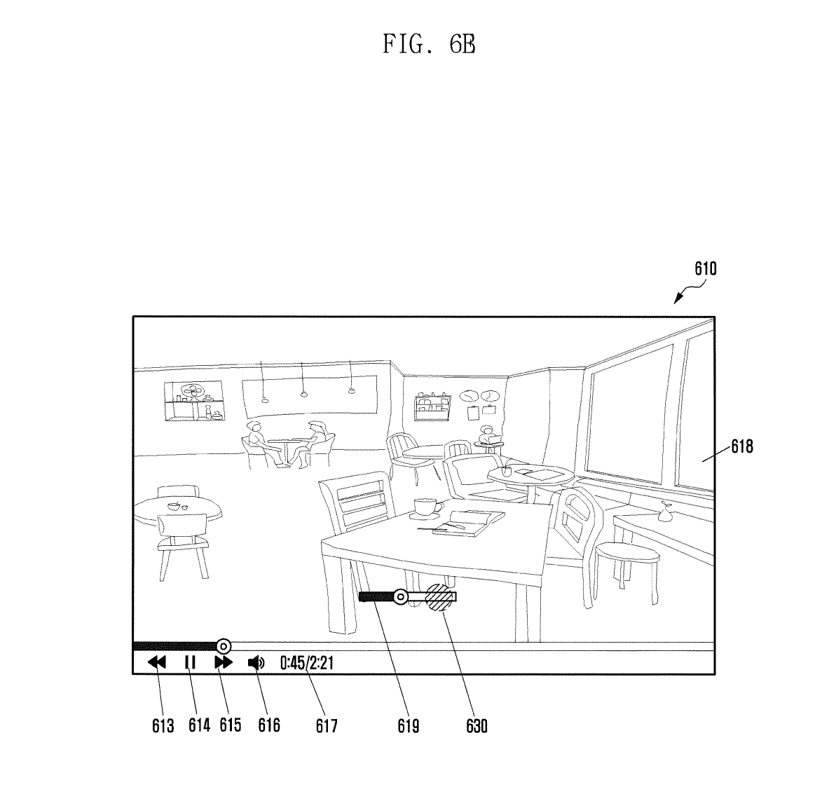

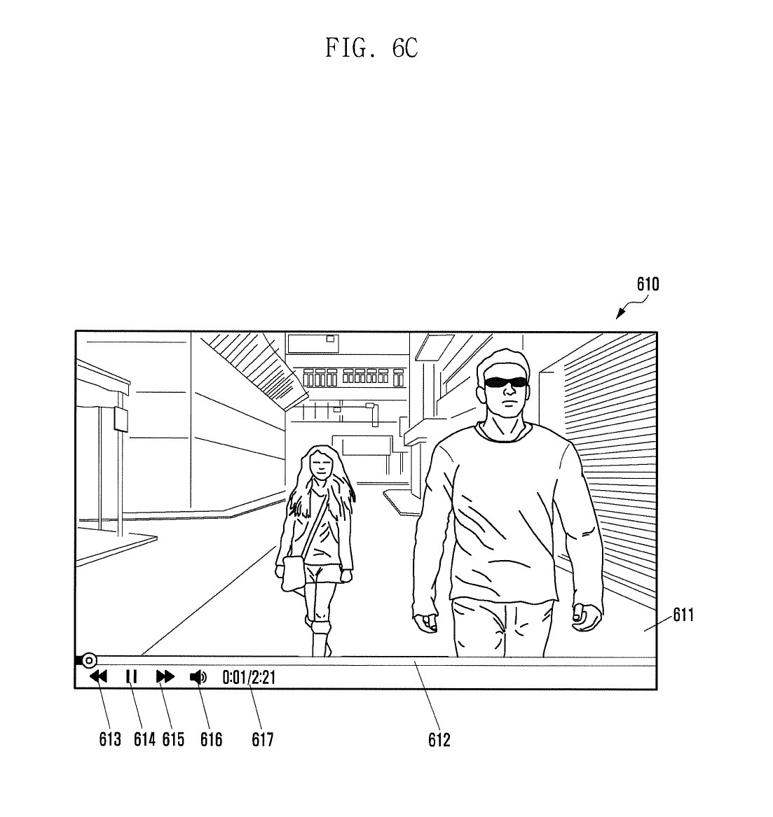

FIGS. 6A, 6B, and 6C are reproduction screens for describing an example process of reproducing a video according to this disclosure.

Referring to FIG. 6A, the processor (for example, the processor 211) controls the display module (for example, the display module 260) to display a player execution image 610 on the screen. The player execution image 610 includes a reproduction frame 611 and a reproduction progress bar 612. Further, the player execution image 610 further includes various function icons or buttons. For example, the player execution image 610 can further include a rewind button 613, a play/pause button 614, a fast forward button 615, a volume control button 616, and a time point of a currently displayed frame (for example, the reproduction frame 611)/an entire time of a corresponding video 617 (for example, 0:01/2:21). The user can perform a touch input (for example, a direct touch, a hovering or the like) on the reproduction progress bar 612. In response to the touch input, the processor 211 can determine a touch area 620. The touch area 620 can include at least a part of the reproduction progress bar 612 and the volume control button 616. The processor 211 can determine the reproduction progress bar 612 as the object selected by the user and the volume control button 616 as the candidate object. When the reproduction progress bar 612 is determined as the object selected by the user, the processor 211 can determine a position of the reproduction progress bar 612 closest to the center point of the touch area 620 as a position corresponding to a new reproduction time point.

Referring to FIG. 6B, the processor 211 starts reproducing the video from the new reproduction time point. For example, the processor 211 makes a control to display the reproduction frame 618 corresponding to a reproduction time point of 45 seconds. When the volume control button 616 is determined as the candidate object, the processor 211 makes a control to display a corresponding volume control bar 619 on the reproduction frame 619. The user performs a touch input on the volume control bar 619. In response to the touch input, the processor 211 determines a touch position 630. The processor 211 determines a position of the volume control bar 619 closest to the center point of the touch position 630 as a volume control position. The processor 211 controls an audio processing module (for example, the audio codec 280) to output an audio signal of the video with a volume corresponding to the determined volume control position.

Referring to FIG. 6C, after the volume control (or simultaneously with the volume control, the processor 211 returns the reproduction time point to a previous time point (for example, 1 second). The display module 260 displays the reproduction frame 611 corresponding to the reproduction time point of 1 second under a control of the processor 211.

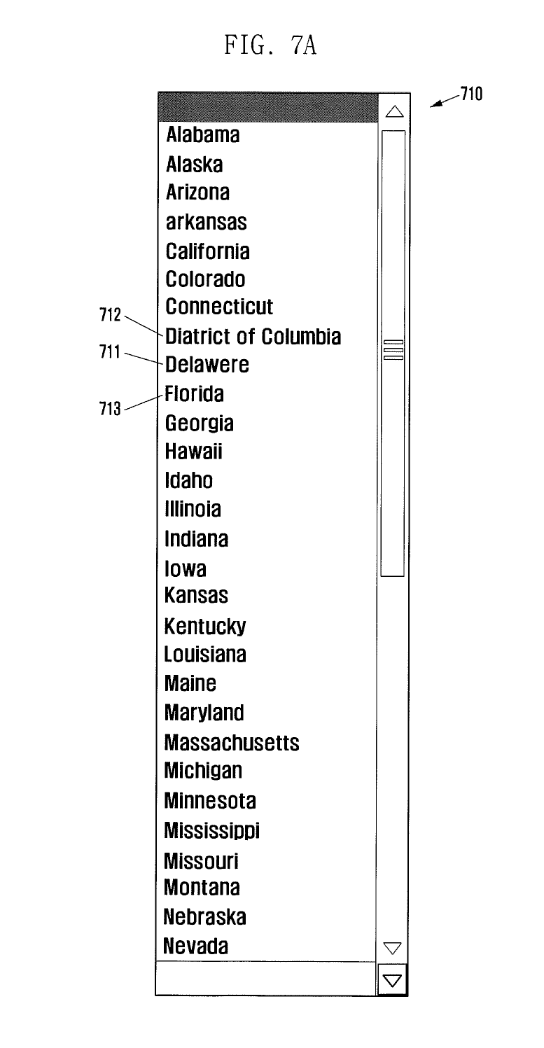

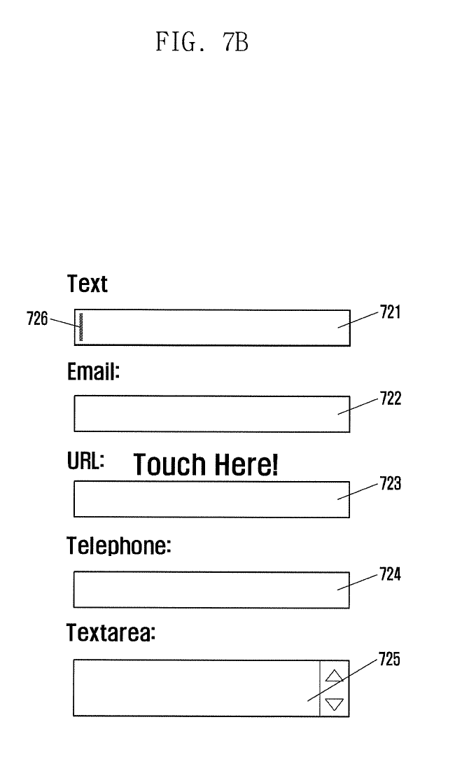

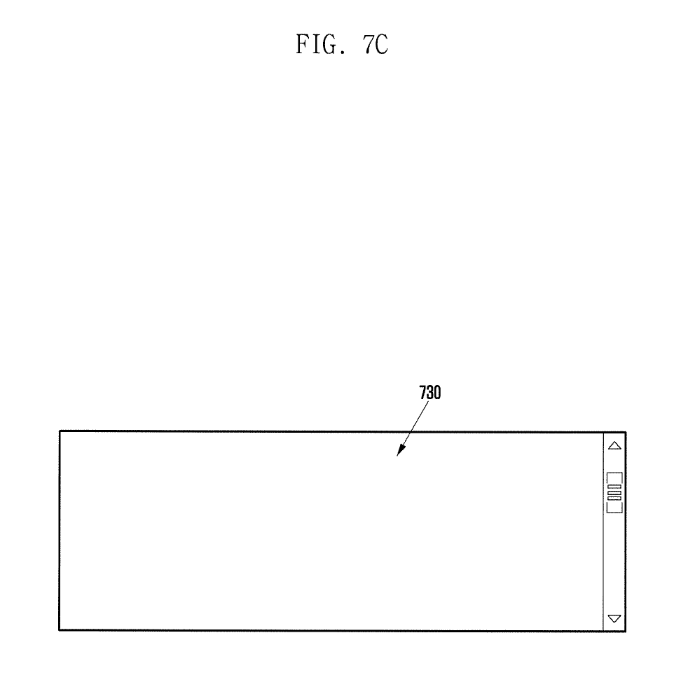

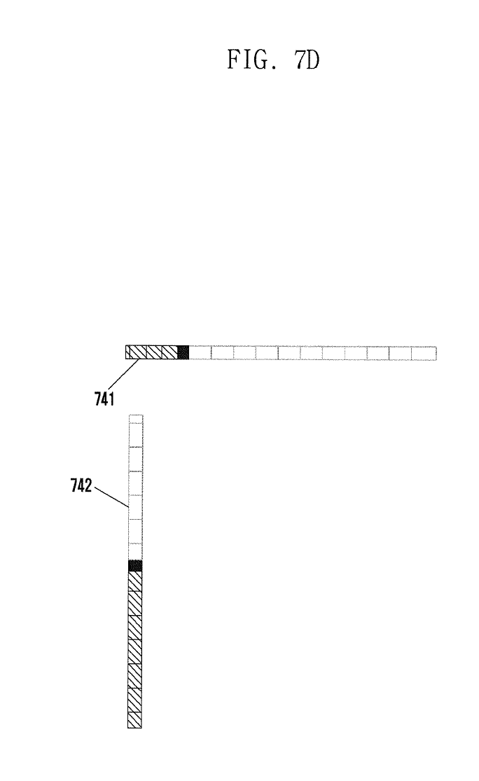

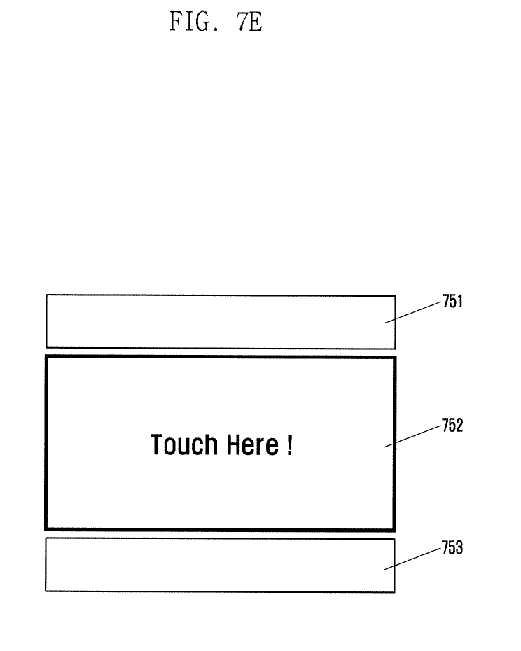

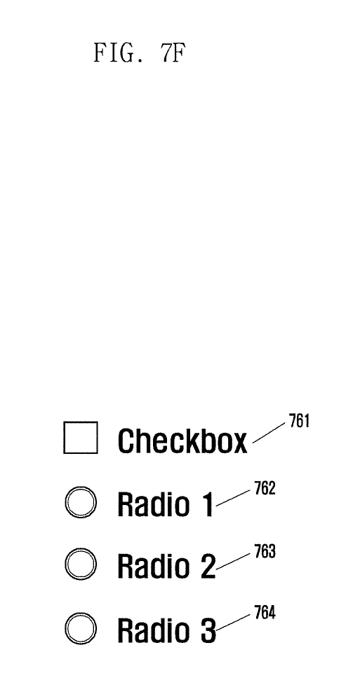

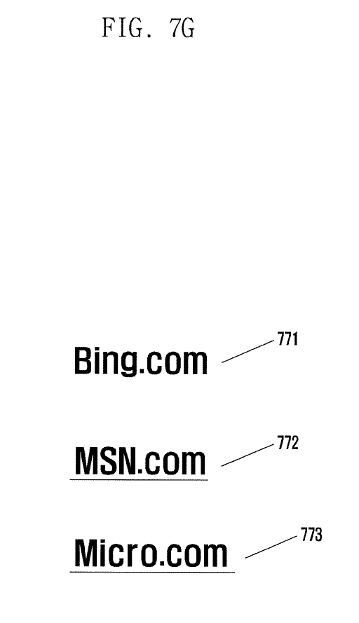

FIGS. 7A, 7B, 7C, 7D, 7E, 7F, and 7G illustrate various objects which can be selected according to a touch input.

Referring to FIG. 7A, the processor (for example, the processor 211) controls the display (for example, the display module 260) to display a list 710. As illustrated in FIG. 7A, the object selection list 710 includes objects close to each other. When the user performs a touch input on the list 710, an object which the user does not intend to select can be selected. For example, the processor 211 recognizes if an object 711 is selected. Then, the processor 211 terminates displaying of the list 710 and controls the display module 260 to display the object 711 in an input window. Further, the processor 211 controls the display module 260 to display a candidate list including at least one object (for example, an object 712) located above the object 711 and at least one object (for example, an object 713) located under the object 711 together with the input window. For example, when at least one object is selected from the candidate list before a designated time elapses from a time point when the selection of the object 711 is recognized, the processor 211 terminates displaying of the candidate list and controls the display module 260 to display the object selected from the candidate list instead of the object 711. When there is no selection by the time the designated time elapses, the processor 211 terminates the displaying of the candidate list and maintains displaying of the object 711 in the input window.

Referring to FIG. 7B, the processor 211 controls the display module 260 to display a plurality of input windows, for example, a text input window 721, an email input window 722, a URL input window 723, a phone number input window 724, and a text area input window 725. When it is recognized that one input window (for example, the text input window 721) is selected by the user from the various input windows, the processor 211 controls the display module 260 to display a cursor 726 within the text input window 721. Further, the processor 211 determines the email input window 722 as the candidate object and controls the display module 260 to display an icon indicating the email input window 722. When the icon is selected, the processor 211 terminates displaying of the icon and controls the display module 260 to display the cursor 726 in the email input window 722.

According to any embodiment, the object can be a text input box 730 illustrated in FIG. 7C, a horizontal scroll bar 741 and a vertical scroll bar 742 illustrated in FIG. 7D, buttons 721, 752, and 753 illustrated in FIG. 7E, check boxes 761, 762, 763, and 764 illustrated in FIG. 7F, and linked addresses 771, 772, and 773 illustrated in FIG. 7G. When the user performs a touch input on the button 752, the processor 211 controls the display module 260 to make a display such that the candidate list overlaps the button 752. The displayed candidate list includes the button 752 and button 751.

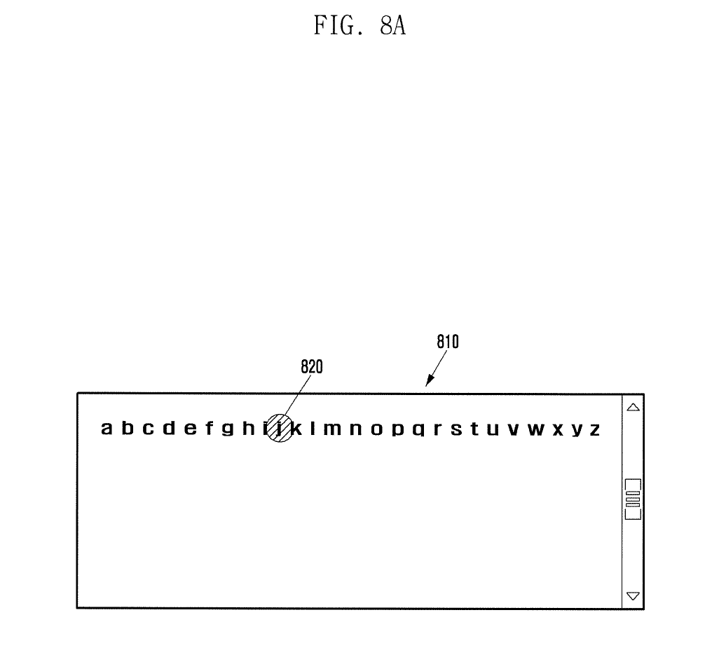

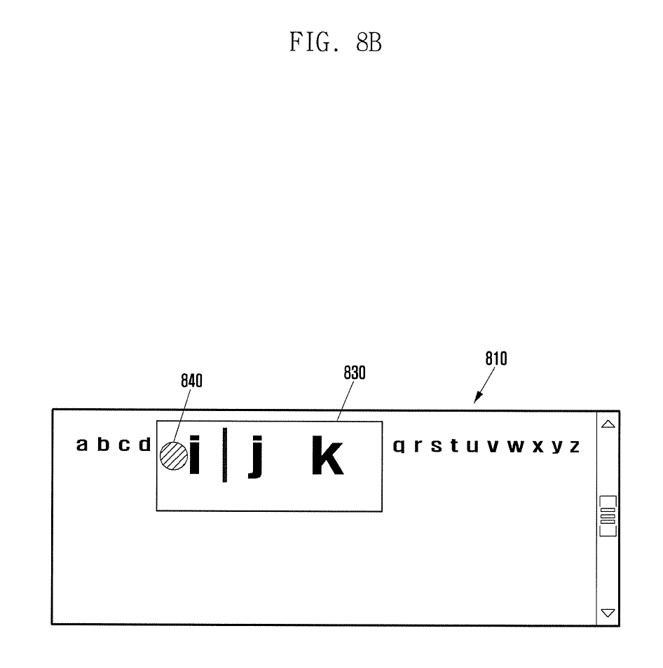

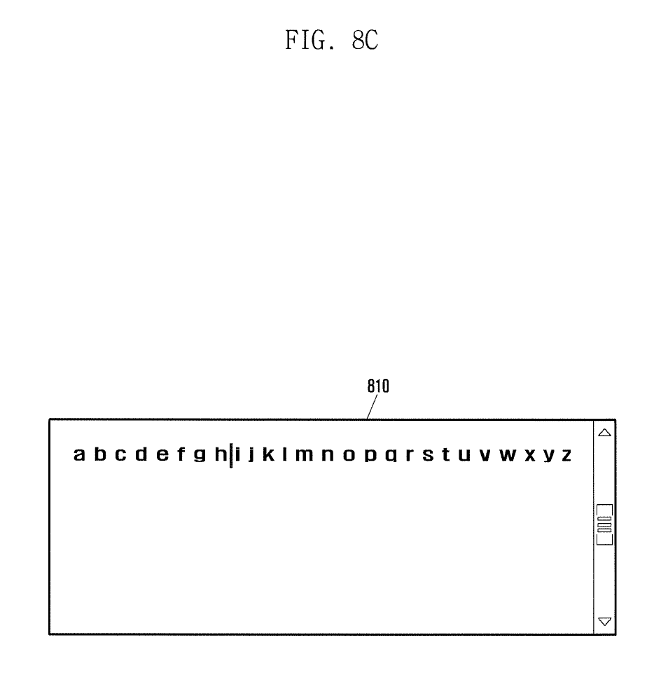

FIGS. 8A, 8B, and 8C are text input boxes for describing a process of reconfiguring a position of a cursor according to this disclosure.

Referring to FIG. 8A, the processor (for example, the processor 211) controls the display (for example, the display module 260) to display a text input box 810. The text input box 810 includes characters. The user performs a touch input on the text input box 810. In response to the touch input, the processor 211 determines a touch area 820 and determines the center point of the touch area 820 as a touch position. The processor 211 determines a display position of the cursor based on the touch position. For example, the processor 211 determines a position before (that is, between “i” and “j”) of a character (for example, “j”) closest to the touch position from among characters (for example, “i”, “j”, and “k”) of which at least a part is included within the touch area 820 as the display position of the cursor. In another example, the processor 211 determines a position after “j” (that is, between “j” and “k”) as the display position of the cursor. The processor 211 controls the display module 260 to display the cursor on the determine display position.

Referring to FIG. 8B, the processor 211 controls the display module 260 to display a popup window 830. The popup window 830 indicates a partial area of the text input box 810 and the processor 211 determines the partial area based on a position of a cursor displayed in the text input box 810. For example, the processor 211 controls the display module 260 to display “the popup window 830 including one or more characters (for example, “i”) located before the cursor, the cursor, and one or more characters (for example, “j” and “k”) located after the cursor”. The display module 260 displays i|(cursor) j k which is enlarged against i|(cursor) j k in the text input box 810 under a control of the processor 211. Further, the display module 260 displays i|(cursor) j k of which intervals therebetween are further separated. The user performs a touch input on the popup window 830. In response to the touch input, the processor 211 determines a touch area 840 and determines the center point of the touch area 840 as a touch position.

Referring to FIG. 8C, the processor 211 changes a display position of the cursor based on the touch position of the popup window 830. For example, when a character closest to the touch position is “i” among the characters in the popup window 830, the processor 211 changes the display position of the cursor from “before j” to “before i”.

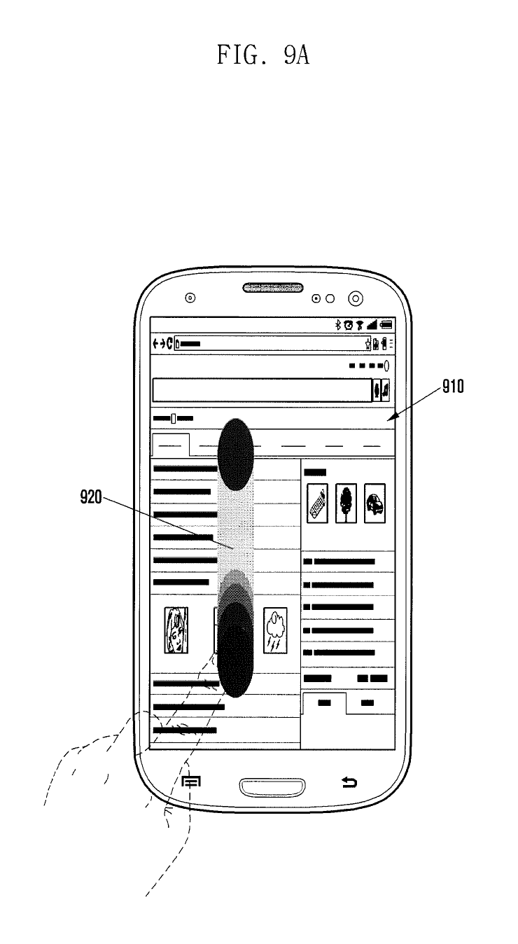

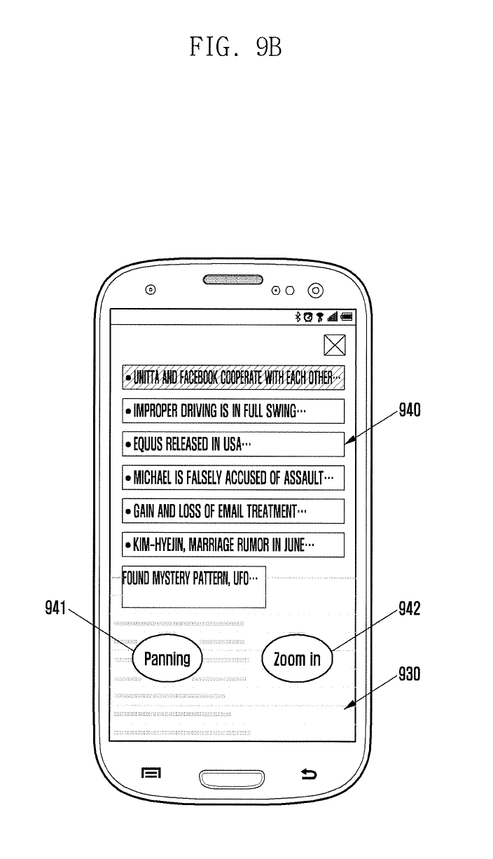

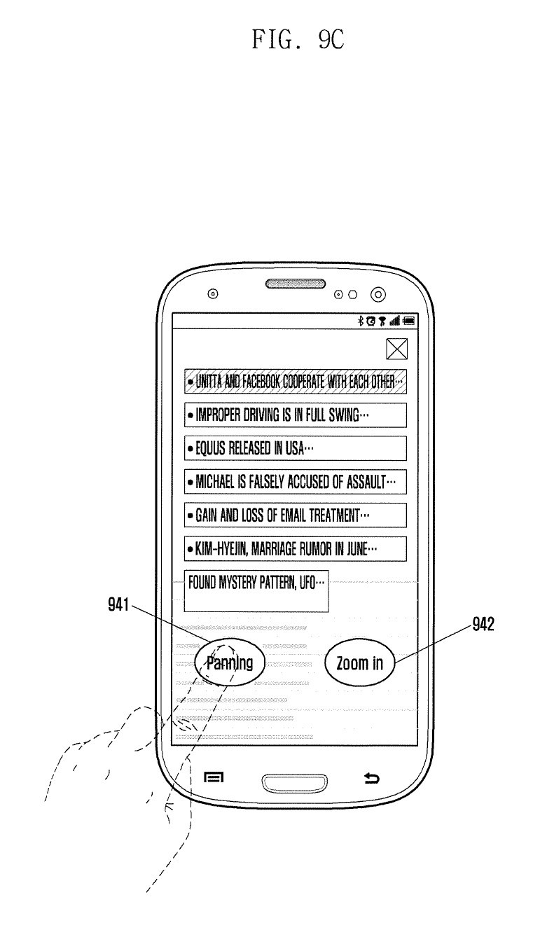

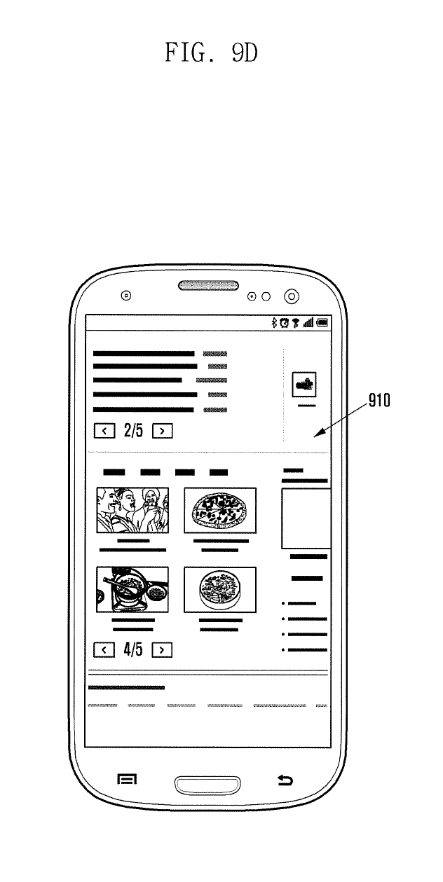

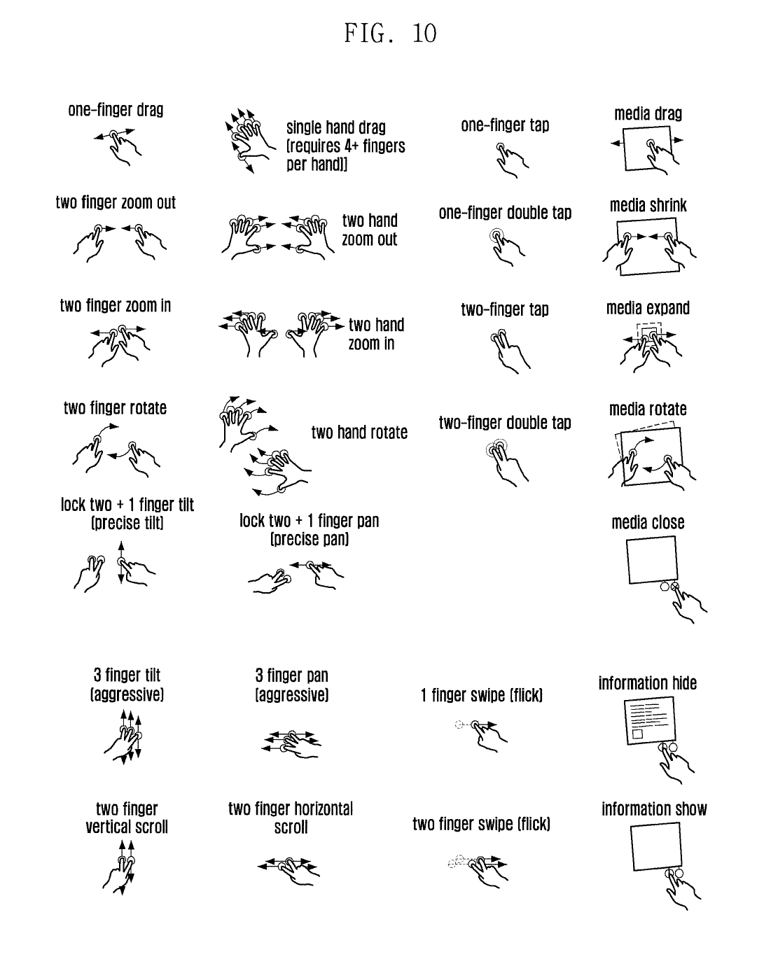

FIGS. 9A, 9B, 9C, and 9D are web browser screens for describing a process of displaying a webpage according to this disclosure. FIG. 10 illustrates various gestures which can be recognized by the processor.

Referring to FIG. 9A, the processor (for example, the processor 211) controls the display (for example, the display module 260) to display a part (for example, a upper part) of a webpage 910 on the screen. The user takes various gestures on the upper part of the webpage 910. For example, the user takes a panning 920. However, the touch panel (for example, the touch panel 252) can recognize it as, for example, a tap, not the panning 920 and transmit an event corresponding to the tap to the processor 211. Such misrecognition can be generated in situations shown in Table 1 below.

TABLE 1

| Gesture | | Gesture | |
|---|---|---|---|
| (user's intention) | Sub-gesture | (misrecognition) | Correction example |
| Tap (click) | 1. finger down | It may be | - when a user's gesture is |
| | 2. movement (which can have | misrecognized as a | recognized as a panning, the |
| | directivity) can be generated | panning due to a | processor determines that a |
| | 3. finger up | movement | tap is associated with the |
| | | | panning based on sub- |
| | | | gestures of the panning (for |
| | | | example, finger down, |
| | | | movement, and finger up) |
| | | | and determines the tap as a |
| | | | candidate gesture. An icon |
| | | | or a button indicating the tap |
| | | | is displayed. |
| Long tap | 1. finger down (for a | When a time of the | - when a user's gesture is |
| | predetermined time or longer) | finger down is | recognized as a tap, a long |
| | 2. movement (which can have | short, it may be | tap, a double tap, and a |
| | directivity) can be generated | misrecognized as a | panning are determined as |
| | 3. finger up | tap | candidate gestures. Icons or |
| Double tap | 1. finger down | When an interval | buttons indicating the |
| | 2. movement can be generated | between a first | candidate gestures are |
| | 3. finger up | finger up and a | displayed. |
| | 4. finger down (shortly) | second finger down | |
| | 5. movement can be generated | is long, it may be | |
| | 6. finger up | misrecognized as a | |
| | | tap | |
| Panning | 1. finger down | Since a movement | |
| | 2. movement | distance is short, it | |
| | 3. finger up | may be | |
| | | misrecognized as a | |
| | | tap | |
| Two finger zoom | 1. first finger down and | An undesired | - when a user's gesture is |
| | second finger down | execution may be | recognized as a first finger |
| | 2. first finger movement and | generated by a first | movement and a second |
| | second finger movement | finger movement | finger movement, an icon or |
| | 3. first finger up and second | | a button indicating a two |
| | finger up | | finger zoom may be |
| | | | displayed as a candidate |
| | | | gesture |

In Table 1, the finger down can be a gesture in which an object (for example, a finger) contacts a touch screen, the movement can be a gesture in which an object moves in a state where the object contacts a touch screen, and a finger up can be a gesture in which a contact of an object is released from a touch screen. Alternatively, in Table 1, the finger down can be a gesture in which an object is close to a touch screen within a preset distance, the movement can be a gesture in which an object moves in a state the object is close to a touch screen within a preset distance, and the finger up can be a gesture in which an object escapes from a touch screen by a preset distance.

Referring to FIG. 9B, the processor 211 can recognizes an object corresponding to a tap and executes a function corresponding to the recognized object. For example, the processor 211 controls the display module 260 to display a webpage 930 linked to the object. Further, the processor 211 controls the display module 260 to display a candidate list 940 on the webpage 930. The candidate list 940 can include icons (for example, a panning icon 941 and a zoom-in icon 942) indicating candidate gestures related to the recognized gesture. Further, the candidate list 940 can include candidate objects. The candidate object may not be displayed. For example, the memory 204 stores environment setting information related to the display of the webpage, and the environment setting information can include a value indicating whether the display of the candidate object is configured as on or off. Further, the environment setting information can include a value indicating whether the display of the candidate gesture is configured as on or off. When the display of the candidate object is configured as off and the display of the candidate gesture is configured as on, the processor 211 controls the display module 260 to display only icons. When the display of the candidate object is configured as on and the display of the candidate gesture is configured as on, the processor 211 controls the display module 260 to display the candidate object and icons. The environment setting information can be information which can be changed by the user. For example, the processor 211 changes environment setting information related to the display of the webpage in response to a user input (for example, a touch input, a key input, or a voice input). When there is no candidate object, the processor 211 controls to display only information indicating the candidate gesture regardless of the environment setting information.

Referring to FIGS. 9C and 9D, the user can touch the panning icon 941 by using a finger. In response to the touch, the processor 211 terminates the displaying of the candidate list 940. Further, the processor 211 controls the display module 260 to display a candidate list 920 on the webpage 910.

There are a variety of user gestures which can be recognized by the processor 221. For example, referring to FIG. 10, the user gestures which can be recognized by the processor 221 may include one finger drag, single hand drag, one finger tap, media drag (the media herein corresponds to, for example, a candidate list), two finger zoom out, two hand zoom out, one finger double tap, media shrink, two finger zoom in, two hand zoom in, two finger tap, media expand, two finger rotate, two hand rotate, two finger double tap, media rotate, lock two+one finger tilt, lock two+one finger pan, media close, three finger tilt, three finger pan, three finger flick, information hide, two finger vertical scroll, two finger horizontal scroll, two finger flick, information show and the like. The gestures illustrated in FIG. 10 can be 2D gestures took in a state where the user brings an object (for example, a finger) into contact with the touch screen or 3D gestures took in a state where the user moves an object (for example, a finger) to the touch screen within a predetermined distance.

According to this disclosure, when the electronic device recognizes an object selected by the user from among other objects, the electronic device executes a function of the recognized object and displays a candidate list. The candidate list can include all objects which have not been selected. Further, the electronic device can determine only some of the objects which have not been selected as candidates and display the determined objects.

According to this disclosure, the electronic device recognizes a user gesture, executes a function of the recognized gesture, and displays information (for example, an icon) indicating the candidate gesture. The electronic device can determine all gestures which can be recognized in a target to be displayed (for example, a webpage) as candidates. Alternatively, the electronic device can determine a gesture related to the recognized gesture among all the gestures as a candidate.

The processor (for example, the processor 211) selects a candidate object from the other objects and selects a candidate gesture from the gestures based on at least one of a touch position, history information, sensitivity, and frequency shown in Table 2 below.

TABLE 2

| | |
|---|---|
| Frequency | - the processor determines a candidate object based on frequency with which the user selects |
| | an object (for example, the number of times by which the user selects the corresponding |
| | object in a recent week). |
| | - the processor determines a candidate gesture based on frequency with which the user |
| | makes a gesture (for example, the number of times by which the user makes the |
| | corresponding gesture in a recent week). |
| Sensitivity | - a task requiring a relatively large throughput of a processor in comparison with another |
| | processor, such as displaying a new webpage or a new window, may be configured to |
| | have high sensitivity. As the sensitivity is higher, objects are highly likely to be |
| | determined as candidates. |
| | - a task requiring a relatively small throughput of a process in comparison with another |
| | processor, such as a state change in a check or a button, may be configured to have low |
| | sensitivity. As the sensitivity is lower, objects are highly likely to be determined |
| | as candidates. |
| | - the processor records a use rate of a system resource (for example, a CPU or a memory) |
| | used for processing a task and also records a time spent processing the corresponding task. |
| | The processor configures the sensitivity of the corresponding task based on the recorded |
| | information. |
| | - the processor stores the recoded information in a DB in a dictionary form. |
| History | - the processor stores error information on a misrecognized object and gesture and stores |
| | correction information on the error-corrected object and gesture. For example, |
| | the error information and the correction information may be interconnected to each other. |
| | - the processor determines a candidate object and/or a candidate gesture based on the error |
| | information and the correction information |
| Locality | - the processor determines a candidate object and/or a candidate gesture based on commands |
| | (for example, a movement and a finger up) which can be located within a predetermined |
| | range from a position on the screen where a command (for example, a gesture made by |
| | the user on the touch screen) is generated or located within a predetermined time from |
| | a time point when a command (for example, a finger down) is generated. |

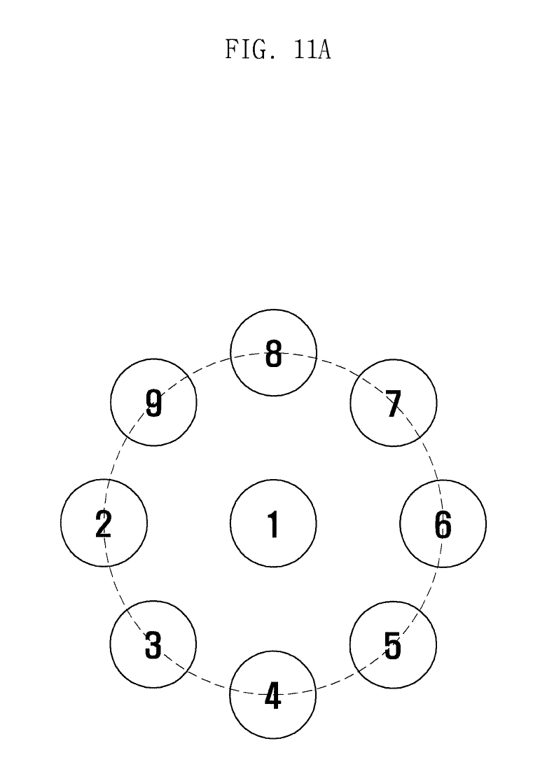

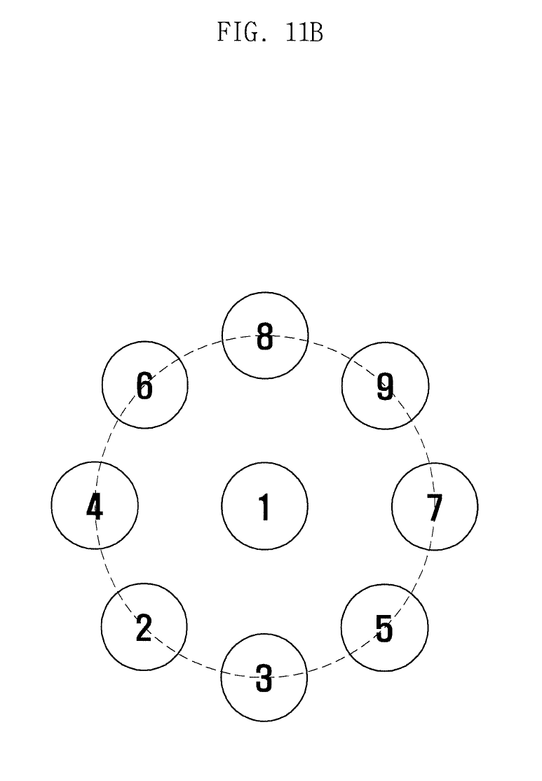

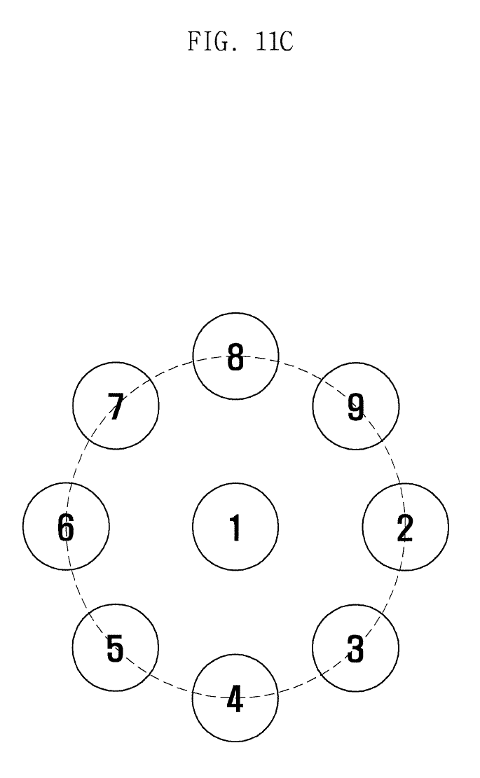

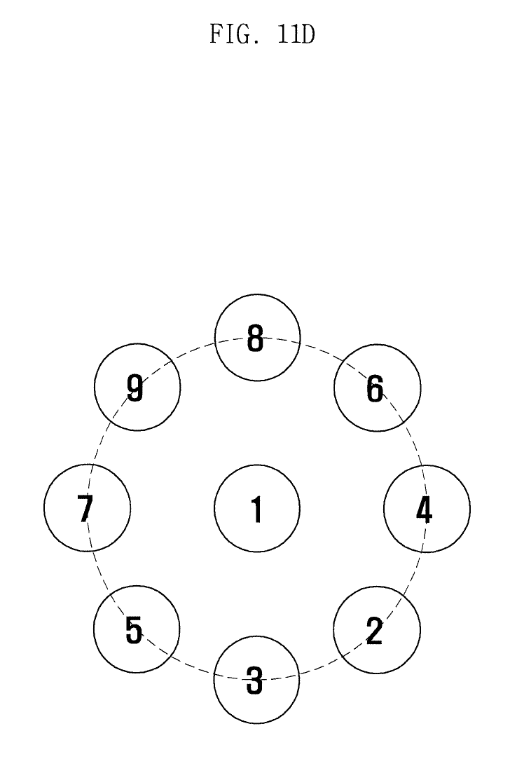

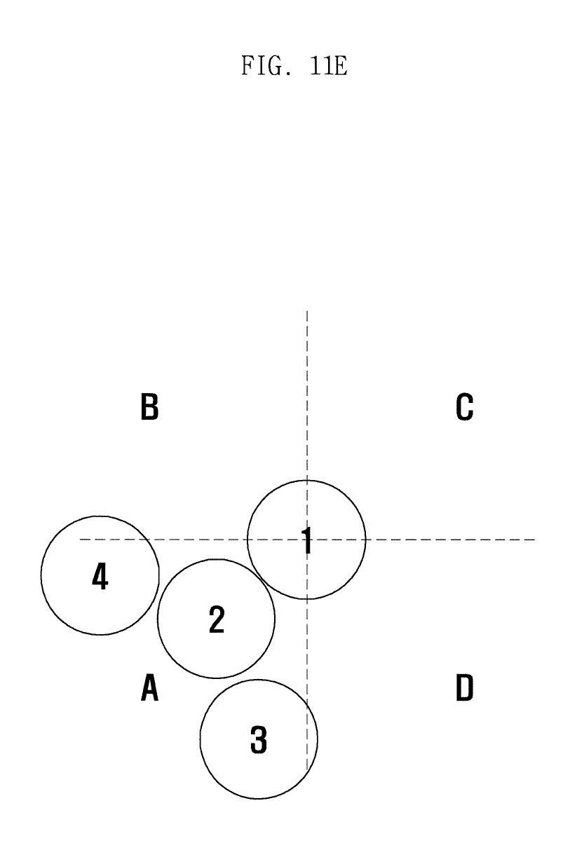

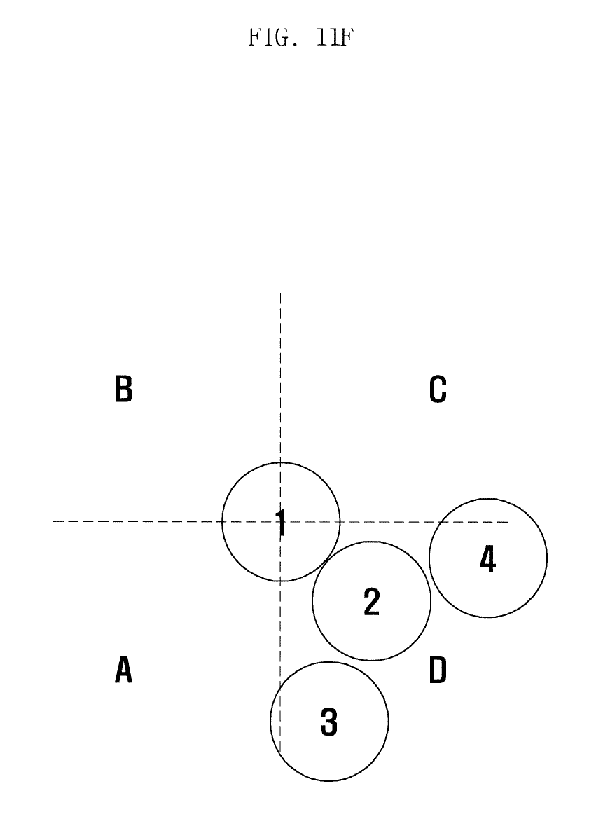

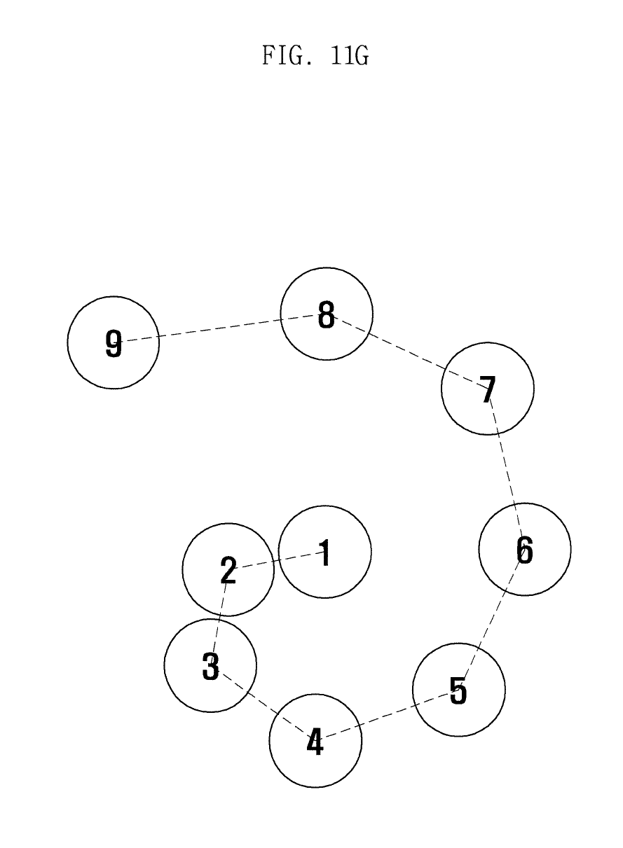

FIGS. 11A, 11B, 11C, 11D, 11E, 11F, and 11G are views describing an example method of arranging candidates.

Referring to FIGS. 11A, 11B, 11C, and 11D, the display (for example, the display module 260) displays candidate 1 (for example, an object or a gesture) having the highest priority among the candidates in the center and display candidates 2 to 9 in the form of circle surrounding candidate 1. When the electronic device 200 is, for example, a smart phone, the processor 211 determines whether the user grips the electronic device 200 by using information measured or detected by the sensor module 240 (for example, the grip sensor 240F). When the user grips the electronic device 200, the processor 211 determines whether the electronic device 200 is gripped by a left hand or a right hand. When it is determined that the hand is the left hand, the processor 211 arranges a candidate having a higher priority in a left side of a candidate having a relatively lower priority so that the user can more easily select the candidate having the higher priority by using a finger (for example, a thumb) of the left hand in a state where the user grips the electronic device 200 with the left hand. For example, the display module 260 displays candidate 2 (see FIGS. 11A and 11B) in a left side under a control of the processor 211. In any embodiment, when it is determined that the hand is the right hand, the processor 211 can arrange a candidate having a higher priority in a right side of a candidate having a relatively lower priority. Referring to FIGS. 11C and 11D, candidate 2 can be displayed in a right side.

Referring to FIGS. 11E and 11F, the candidates are arranged in one of various areas of the screen. For example, the processor 211 can arrange candidate 1 having the highest priority in a predetermined position of the screen (for example, the center of the screen) and divide the screen into quadrants A, B, C, and D based on the position where candidate 1 is arranged. When it is determined that the hand is the right hand, the processor 211 arranges the candidates having the following priorities (for example, candidates 2, 3, and 4) in quadrant A. When it is determined that the hand is the right hand, the processor 211 arranges candidates 2, 3, and 4 in quadrant D.

Referring to FIG. 11G, the processor 211 arranges candidate 1 having the highest priority in one position of the screen (for example, the center of the screen). Further, the processor 211 can sequentially arrange the candidates having the following priorities (for example, candidates 2, 3, 4, 5, 6, 7, 8, and 9) in a spiral form.

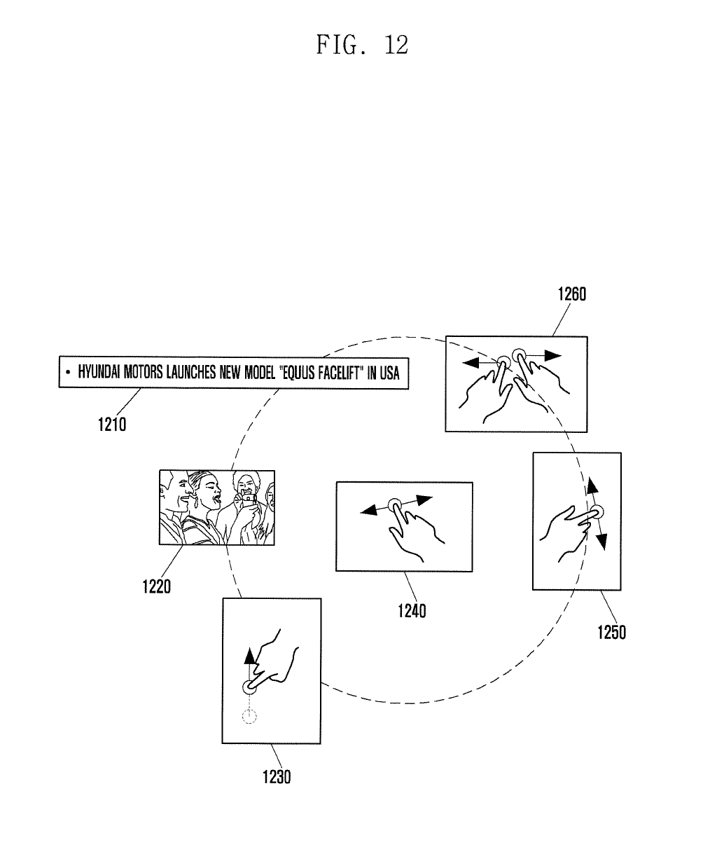

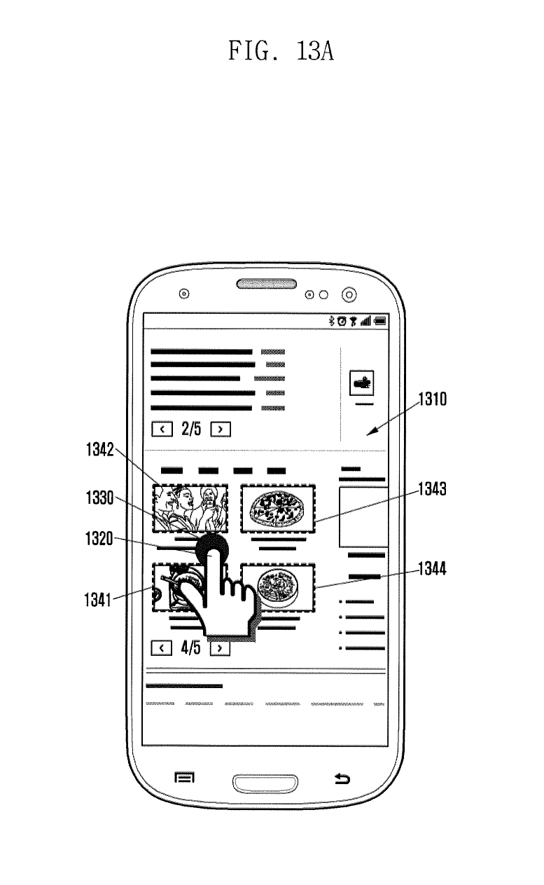

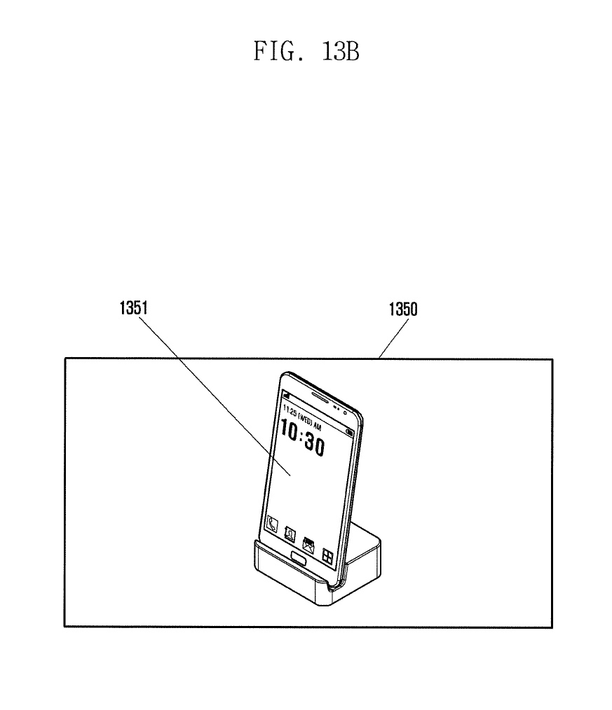

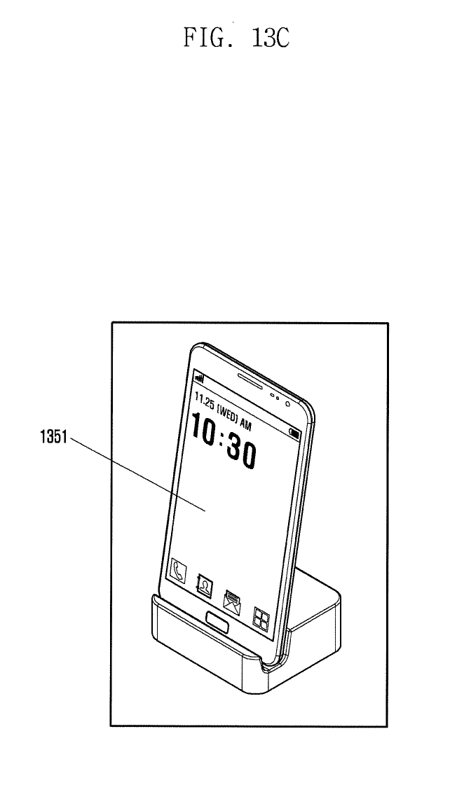

FIG. 12 and FIGS. 13A, 13B, and 13C are views describing an example method of displaying candidates in various forms.

Referring to FIG. 12, the display (for example, the display module 260) displays a candidate object 1210 in a text form under a control of the processor (for example, the processor 211) so that the user can easily identify the corresponding object. The display module 260 displays a candidate object 1220 in a thumbnail form. Further, the display module 260 displays candidate gestures 1230, 1240, 1250, and 1260 in an icon form generated from images of the corresponding gestures.

Referring to FIG. 13A, the processor 211 receives an event related to a tap 1330 of a finger 1320 on a webpage 1310 from the touch panel 252 and determines a touch position of the tap 1330. The processor 211 recognizes an object selected by the user based on the touch position. Further, the processor 211 selects a candidate object from the remaining objects except for the selected object in the webpage 1310 based on at least one of a touch position, history information, sensitivity, and frequency. For example, the processor 211 determines an area within a preset radius with the touch position as the center and determines an object of which at least a part is included within the touch area as a candidate. When each of the determined candidates is an image, the processor 211 controls the display module 260 to display the candidate (for example, candidates 1341, 1342, 1343, and 1344) in the thumbnail form.

Referring to FIGS. 13B and 13C, when the candidate is an image 1350, the processor reduces the image 1350 into a thumbnail and controls to display the thumbnail. Alternatively, the processor 211 can extract a part (for example, a main content 1351) from the image 1350, reduce the extracted main content 1351 into a thumbnail, and control to display the thumbnail. The processor 211 can use tag information tagged into the image 1350 to extract the main content 1351. The tag information refers to additional information related to the image and a file format is, for example, an Exchangeable image file format (Exif). For example, the tag information can include position information of the object (for example, the main content 1351) and identification information of the object (for example, a person mane, an address, a phone number, and an object name). When there is no tag information, the processor 211 can extract the main content 1351 based on known various image recognition schemes.

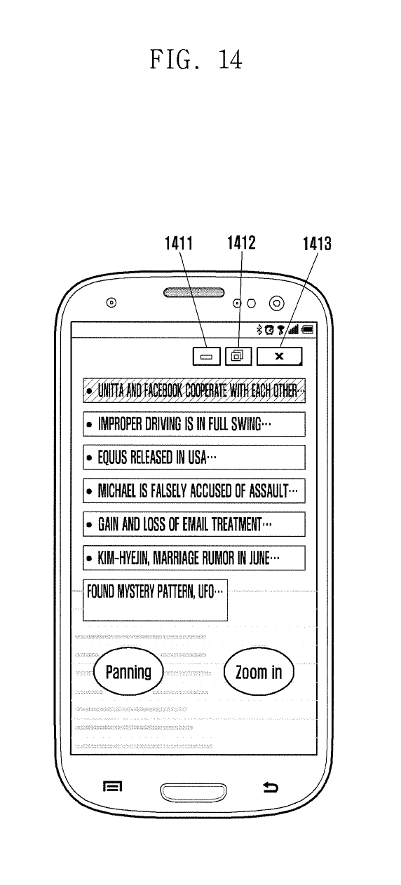

FIG. 14 is a view describing an example of a method of operating a candidate list according to this disclosure.

Referring to FIG. 14, the processor (for example, the processor 211) controls the display (for example, the display module 260) to display a candidate list 1410. The candidate list 1410 can include a button 1411 for minimizing the candidate list 1410, a button 1412 for maximizing the candidate list 1410, and a button 1413 for terminating the displaying of the candidate list 1410. When the user selects the minimization button 1411, the processor 211 controls the display module 260 to display information (for example, an icon) corresponding to the candidate list 1410. When the user selects the maximization button 1412, the processor 211 controls the display module 260 to display the candidate list 1410 in an entire screen. When the user selects the termination button 1413, the processor 211 terminates the displaying of the candidate list 1410.

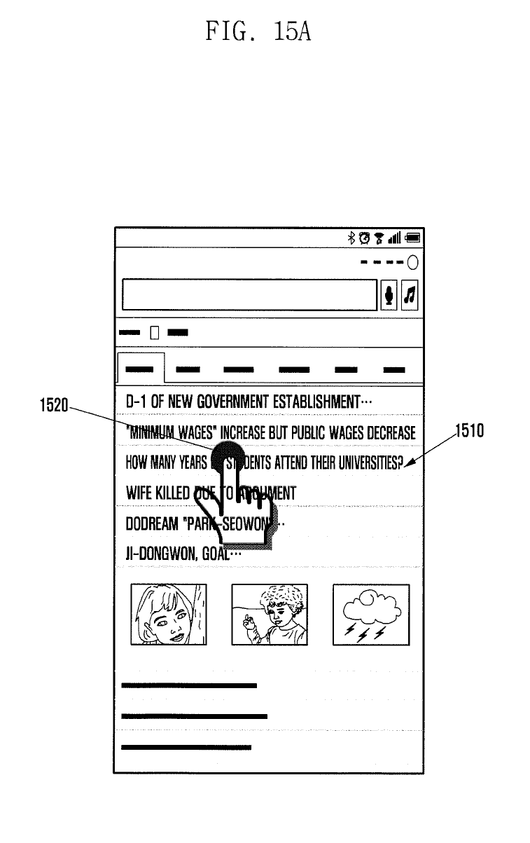

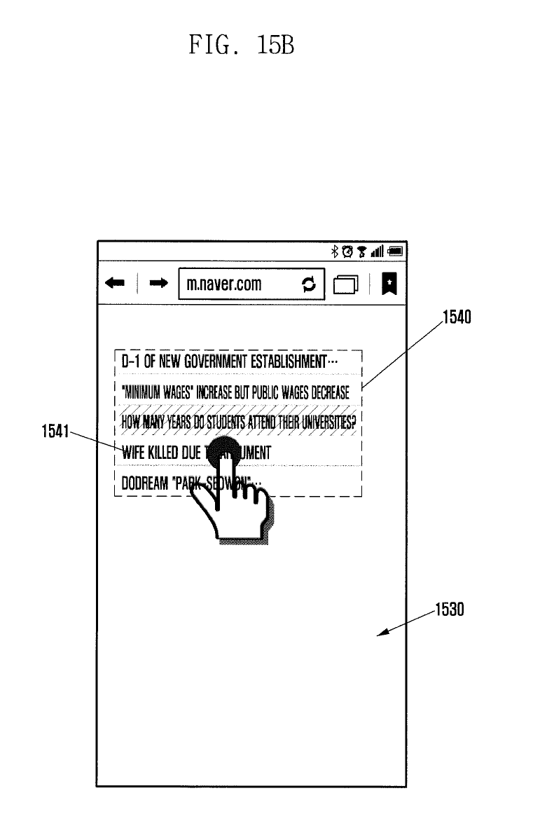

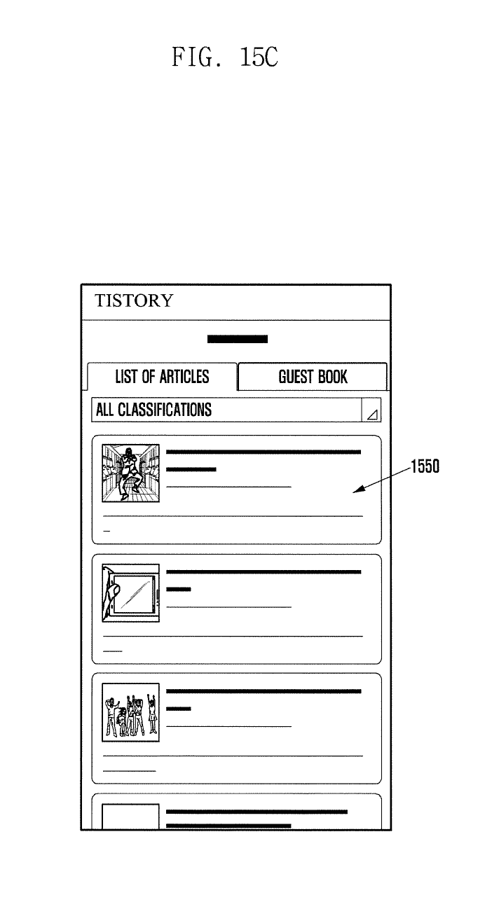

FIGS. 15A, 15B, and 15C are web browser screens for describing a process of displaying a webpage according to this disclosure.

Referring to FIG. 15A, the processor (for example, the processor 211) controls the display (for example, the display module 260) to display a webpage 1510. The processor 211 receives an event related to a touch input (for example, a tap 1520) in a webpage 1510) from the touch panel 252.

Referring to FIG. 15B, the processor 211 recognizes an object corresponding to the tap 1520 and loads a webpage corresponding to the recognized object (for example, read the webpage from the memory or download the webpage through the communication module 230 from an external device). During the loading of the webpage, the processor 211 controls the display module 260 to display a loading guidance image 1530. Further, the processor 211 generates a candidate list 1540 and controls the display module 260 to display a candidate list 1540 on the loading guidance image 1530. The user can select a candidate object 1541 from the candidate list 1540.

Referring to FIG. 15C, in response to the selection of the candidate object 1541, the processor 211 cancels the loading, loads a webpage 1550 corresponding to the candidate object 1541, and controls the display module 260 to display the webpage 1550.

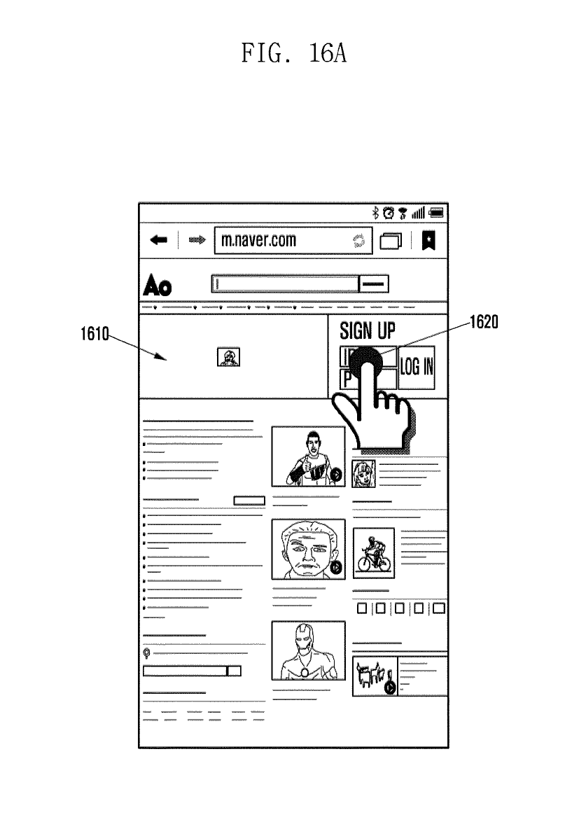

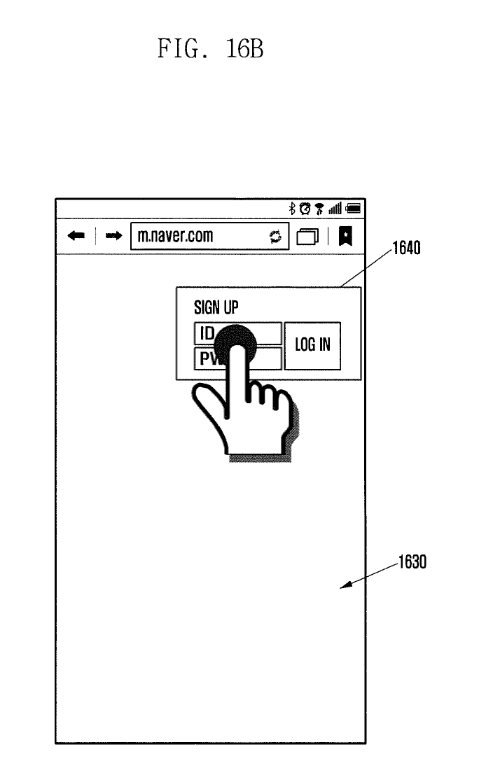

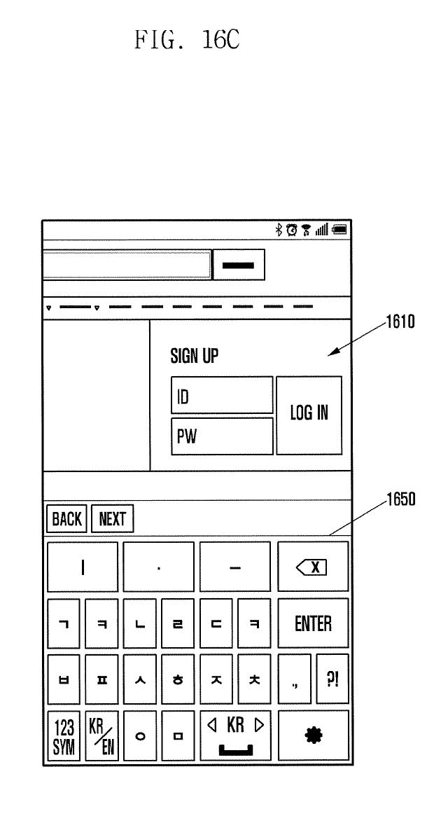

FIGS. 16A, 16B, and 16C are web browser screens for describing a process of displaying a webpage according to this disclosure.

Referring to FIG. 16A, the processor (for example, the processor 211) controls the display (for example, the display module 260) to display a webpage 1610. The processor 211 receives an event related to a touch input (for example, a tap 1620) in a webpage 1610 from the touch panel 252.

Referring to FIG. 16B, the processor 211 recognizes an object corresponding to a tap 1620 and loads a webpage corresponding to the recognized object. During the loading of the webpage, the processor 211 controls the display module 260 to display a guidance image 1630. Further, the processor 211 controls the display module 260 to display a candidate object (for example, an input window 1640) on a loading guidance image 1630. The user selects the input window 1640.

Referring to FIG. 16C, in response to the selection of the input window 1640, the processor 211 cancels the loading and controls the display module 260 to display the webpage 1610 again. In addition, in response to the selection of the input window 1640, the processor 211 controls the display module 260 to display a keypad 1650 on the webpage 1610.

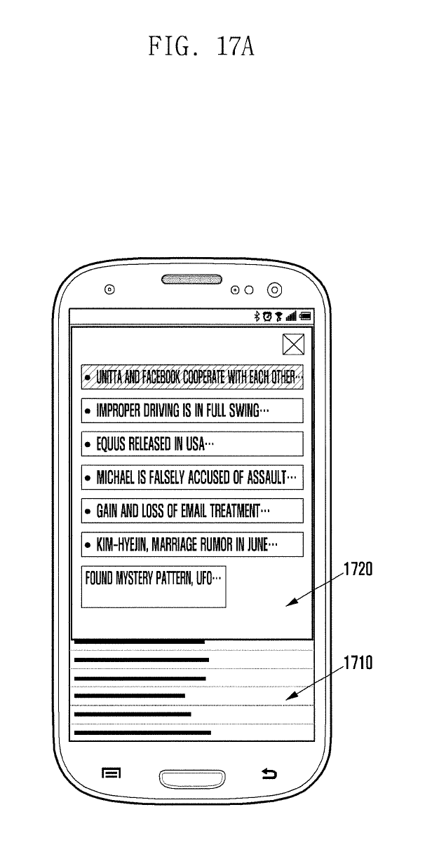

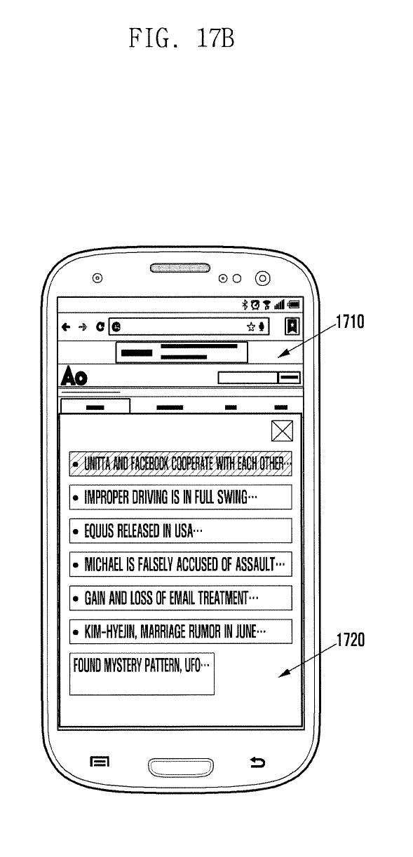

FIGS. 17A and 17B are views describing an example method of placing a list of candidate objects on a screen according to this disclosure.

Referring to FIG. 17A, the processor (for example, the processor 211) controls the display (for example, the display module 260) to display a webpage 1710. Further, the processor 211 controls the display module 260 to display a candidate list 1720 on the webpage 1710.

Referring to FIG. 17B, the processor 211 splits the screen into, for example, two areas and controls the display module 260 to display the webpage 1710 on an upper area of the screen and the candidate list 1720 on a lower area of the screen.

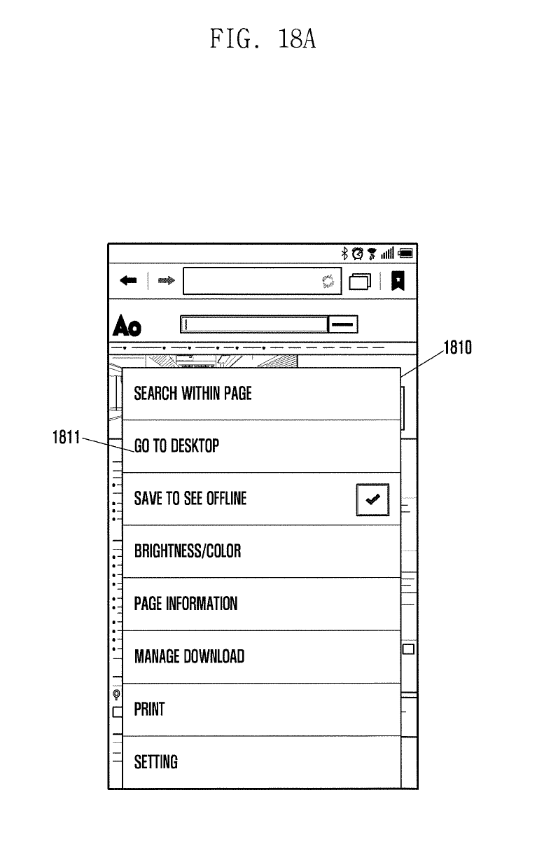

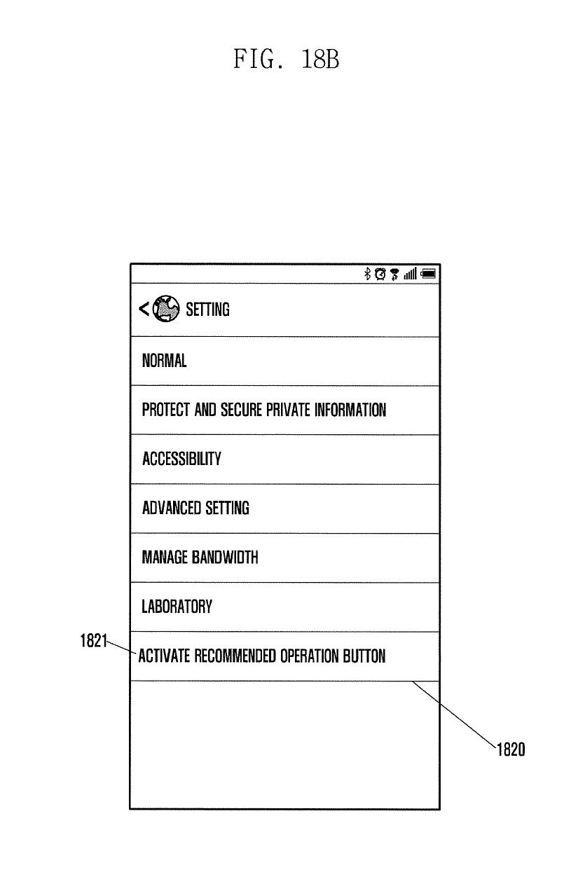

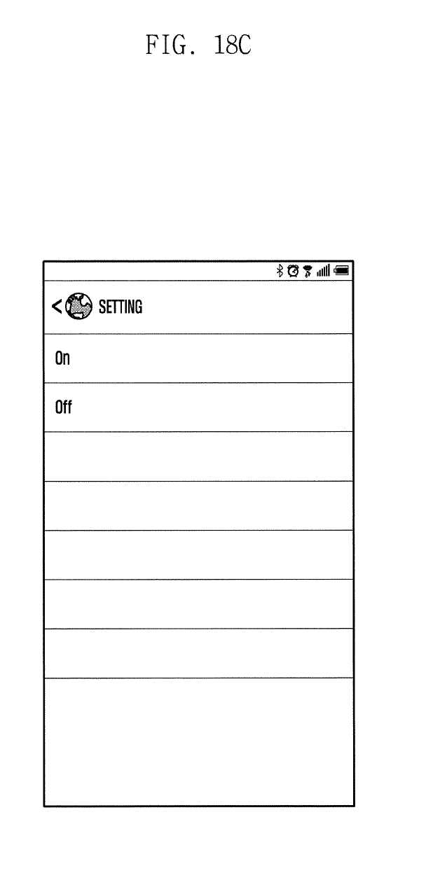

FIGS. 18A, 18B, and 18C are views describing an example method of configuring whether to operate a candidate list according to this disclosure.

Referring to FIG. 18A, the processor (for example, the processor 211) controls the display (for example, the display module 260) to display environment setting information 1810. The user performs a touch input (for example, a tap) on a desktop view item 1811 in the environment setting information 1810. Referring to FIG. 18B, in response to the selection of the item 1811, the processor 211 controls the display module 260 to display setting information 1820 of the item 1811. The user can perform a touch input (for example, a tap) on a “recommended operation button activation” item 1821 in the setting information 1820. Referring to FIG. 18C, in response to the selection of the item 1821, the processor 211 can control the display module 260 to display setting information 1830 of the item 1821. When the user selects ON in the setting information 1830, the processor 211 performs a function of determining a candidate (for example, a candidate object or a candidate gesture) to display the determined candidate. When the user selects OFF, the above function is not performed.

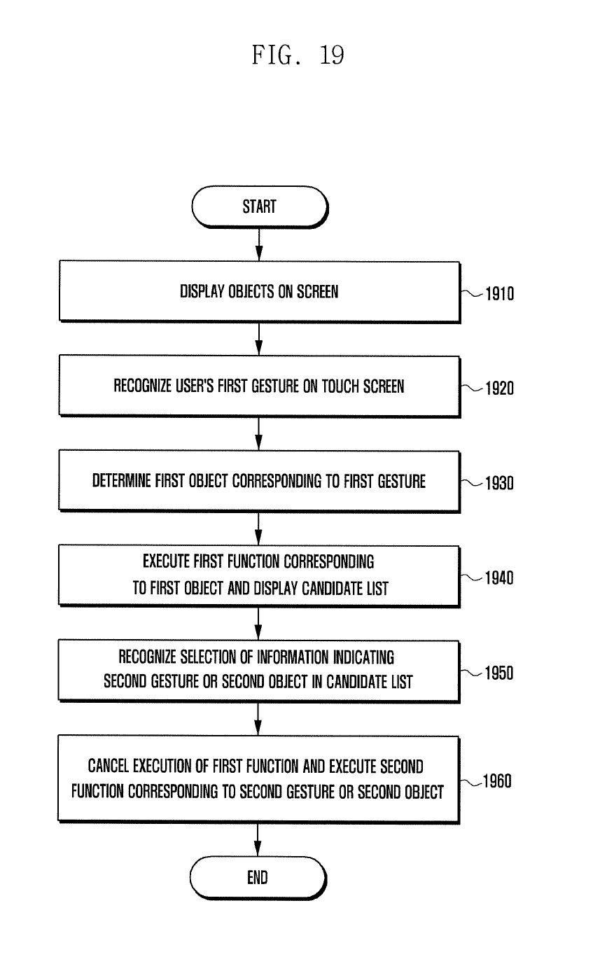

FIG. 19 is a flowchart illustrating an example method of executing a function according to this disclosure.

Referring to FIG. 19, in operation 1910, the electronic device (for example, the electronic device 200) displays objects (for example, an image, text or the like included in a first webpage) on the touch screen. In operation 1920, the electronic device 200 recognizes a first gesture of the user performed on the touch screen. In operation 1930, the electronic device 200 determines a first object corresponding to the first gesture among the objects. In operation 1940, the electronic device 200 executes a first function corresponding to the first object. Further, in operation 1940, the electronic device 200 determines at least one of the objects except for the first object as a candidate and displays a candidate list including the candidate object. In addition, in operation 1940, the electronic device 200 determines at least one of the gestures except for the first gesture as a candidate, inserts information on the determined candidate gesture into the candidate list, and displays the candidate list. In operation 1950, the electronic device 200 recognizes the selection of information on a second gesture or a second object in the candidate list. In response to the selection of the information on the second gesture or the second object, the electronic device 200 cancels the execution of a first function and executes a second function corresponding to the second gesture or the second object in operation 1960.

In an embodiment, a method includes displaying a plurality of objects through a display functionally connected to the electronic device. The method also includes obtaining an input corresponding to a first object among the plurality of objects. The method further includes determining a second object related to the input among the plurality of objects. The method includes displaying execution information of a function corresponding to the first object and object information related to the second object through the display.

The determining of the second object can include determining a touch area related to the input and selecting an object of which at least a part is displayed in the touch area as the second object.

The displaying of the execution information and the object information can include simultaneously displaying the execution information and the object information. Alternatively, the displaying of the execution information and the object information can include displaying the execution information. The method can also include obtaining a designated user input related to the display. The method can further include displaying the object information based on the designated user input. Alternatively, the displaying of the execution information and the object information can include displaying object information related to the first object.

The method can further comprise canceling an execution of the function corresponding to the first object in response to an input corresponding to the object information related to the second object.

The method can further comprise obtaining a second input corresponding to the object information related to the second object and displaying execution information related to a function corresponding to the second input.

The method can further comprise terminating the displaying of the object information when a preset time elapses. The preset time can include a loading time for which data for the execution of the function is loaded. The loading time can include a time for which the data is read from a memory or a time for which the data is downloaded from an external device. While the data is loaded, designated information for loading guidance is displayed together with the object information.

The displaying of the execution information and the object information can include determining one or more objects as a candidate object from the plurality objects except for the first object and determining one or more second inputs except for the input as a candidate input and displaying input information related to the candidate input and the candidate object. The determining of the candidate input can include determining one or more inputs related to the input as the candidate input based on sub inputs of the input.

The determining of the second object can include determining a touch position of a touch screen corresponding to the input. The method can also include determining a preset area with the touch position as a center as the touch area. The method can further include determining an object of which at least a part exists within the touch area as a candidate object.

In an embodiment, a method can include obtaining an input by a user. The method can also include displaying execution information of a function corresponding to the obtained input and input information related to one or more inputs except for the obtained input through a display functionally connected to the electronic device.

In an embodiment, an electronic device can include a display module displaying a plurality of objects. The electronic device can also include a touch panel installed in a touch screen of the display module. The electronic device can further include a processor. The processor obtains an input corresponding to a first object among the objects through the touch panel, determines a second object related to the input among the objects, and controls the display module to display execution information of a function corresponding to the first object and object information related to the second object.

The processor can determine a touch area related to the input and select an object of which at least a part is displayed in the touch area as the second object.

The processor can cancel an execution of the function corresponding to the first object in response to an input corresponding to the object information related to the second object.

The processor can obtain a second input corresponding to the object information related to the second object and control the display module to display execution information of a function corresponding to the second input.

In an embodiment, an electronic device can include a display module including a touch screen with a touch pane. The electronic device can also include a processor configured to obtain an input of a user through the touch panel and control the display module to display execution information of a function corresponding to the obtained input and input information related to one or more inputs except for the obtained input.

The method according to this disclosure as described above can be implemented as a program command which can be executed through various computers and recorded in a computer-readable recording medium. The recording medium can include a program command, a data file, and a data structure. Further, the program command can be specially designed and configured for the present disclosure or may be used after being known to those skilled in computer software fields. The recording medium can include magnetic media such as a hard disk, a floppy disk and a magnetic tape, optical media such as a Compact Disc Read-Only Memory (CD-ROM) and a Digital Versatile Disc (DVD), magneto-optical media such as a floptical disk, and hardware devices such as a Read-Only Memory (ROM), a Random Access Memory (RAM) and a flash memory. In addition, the program instructions may include high class language codes, which can be executed in a computer by using an interpreter, as well as machine codes made by a compiler.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of processing an object through an electronic device, the method comprising:
displaying a plurality of objects through a display functionally connected to the electronic device;
obtaining an input corresponding to a first object among the plurality of objects;
determining a second object related to the input among the plurality of objects; and
displaying execution information of a function corresponding to the first object and object information related to the second object through the display.

2. The method of claim 1, wherein determining the second object comprises:
determining a touch area related to the input; and
selecting an object of which at least a part is displayed in the touch area as the second object.

3. The method of claim 1, wherein displaying the execution information and the object information comprises simultaneously displaying the execution information and the object information.

4. The method of claim 1, wherein displaying the execution information and the object information comprises:
displaying the execution information;
obtaining a designated user input related to the display; and
displaying the object information based on the designated user input.

5. The method of claim 1, wherein displaying the execution information and the object information comprises displaying object information related to the first object.

6. The method of claim 1, further comprising canceling an execution of the function corresponding to the first object in response to an input corresponding to the object information related to the second object.

7. The method of claim 1, further comprising:
obtaining a second input corresponding to the object information related to the second object; and
displaying execution information related to a function corresponding to the second input.

8. The method of claim 1, further comprising terminating the displaying of the object information when a preset time elapses.

9. The method of claim 8, wherein the preset time includes a loading time for which data for the execution of the function is loaded.

10. The method of claim 9, wherein the loading time includes a time for which the data is read from a memory or a time for which the data is downloaded from an external device.

11. The method of claim 9, further comprising displaying information designated for loading guidance together with the object information while the data is loaded.

12. The method of claim 1, wherein displaying the execution information and the object information comprises:
determining one or more objects as a candidate object from the plurality objects except for the first object and determining one or more second inputs except for the input as a candidate input; and
displaying input information related to the candidate input and the candidate object.

13. The method of claim 12, wherein determining the candidate input comprises determining one or more inputs related to the input as the candidate input based on sub inputs of the input.

14. The method of claim 1, wherein the determining of the second object comprises:
determining a touch position of a touch screen corresponding to the input;
determining a preset area with the touch position as a center as the touch area; and
determining an object of which at least a part exists within the touch area as a candidate object.

15. A method of processing an object through an electronic device, the method comprising:
obtaining an input by a user; and
displaying execution information of a function corresponding to the obtained input and input information related to one or more inputs except for the obtained input through a display functionally connected to the electronic device.

16. An electronic device comprising:
a display module configured to display a plurality of objects, wherein the display module includes a touch screen having a touch panel; and
a processor configured to obtain an input corresponding to a first object among the objects through the touch panel, determine a second object related to the input among the objects, and control the display module to display execution information of a function corresponding to the first object and object information related to the second object.

17. The electronic device of claim 16, wherein the processor is configured to determine a touch area related to the input and select an object of which at least a part is displayed in the touch area as the second object.

18. The electronic device of claim 16, wherein the processor is configured to cancel an execution of the function corresponding to the first object in response to an input corresponding to the object information related to the second object.

19. The electronic device of claim 16, wherein the processor is configured to obtain a second input corresponding to the object information related to the second object and control the display module to display execution information of a function corresponding to the second input.

20. An electronic device comprising:
a display module, wherein the display module includes a touch screen having a touch panel; and
a processor configured to obtain an input of a user through the touch panel and control the display module to display execution information of a function corresponding to the obtained input and input information related to one or more inputs except for the obtained input.
